(19) United States
(12) Patent Application Publication
(10) Pub. No.: US 2020/0347302 A1
(43) Pub. Date: Nov. 5, 2020

(54) LIQUID CRYSTAL COMPOSITION CONTAINING A FIVE-MEMBERED HETEROCYCLIC RING, REVERSE-MODE POLYMER DISPERSED LIQUID CRYSTAL ELEMENT, AND ASSOCIATED SELECTIVELY DIMMABLE DEVICE

(71) Applicant: NITTO DENKO CORPORATION, Osaka (JP)

(72) Inventors: Sazzadur Rahman Khan, Oceanside, CA (US); Hiep Luu, San Marcos, CA (US)

(21) Appl. No.: 16/962,933

(22) PCT Filed: Jan. 24, 2019
(86) PCT No.: PCT/US2019/014992

§ 371 Date: Jul. 17, 2020

Related U.S. Application Data
(60) Provisional application No. 62/621,222, filed on Jan. 24, 2018.
(60) Provisional application No. 62/630,368, filed on Feb. 14, 2018.

(51) Int. Cl. C09K 19/34; C09K 19/54; C09K 19/58; G02F 1/1334; G02F 1/1337

(52) U.S. Cl. CPC C09K 19/3497; C09K 19/3491; G02F 1/133723; C09K 19/586; G02F 1/1334; C09K 19/544

(57) ABSTRACT

Described herein are liquid crystal compositions containing a five-membered heterocyclic ring that can allow for the adjustment of their refractive indices under the application of an electric field. In addition, selectively dimmable reverse-mode polymer dispersed liquid crystal (PDLC) elements and devices using the aforementioned compositions are also described, which are transparent when no voltage is applied and opaque when a voltage is applied.

### CROSS-REFERENCE TO RELATED APPLICATIONS

This application claims the benefit of U.S. Provisional Application Ser. No. 62/621,222, filed Jan. 24, 2018, and U.S. Provisional Application Ser. No. 62/630,368, filed Feb. 14, 2018, which are incorporated by reference herein in their entirety.

### BACKGROUND

### Field

The embodiments in this disclosure relate to compounds or compositions having both liquid and crystalline properties. These embodiments also include elements and devices using the aforementioned compounds or compositions.

### Description of the Related Art

In the field of windows, smart windows are attractive alternatives to conventional mechanical shutters, blinds, drapes, hydraulic methods of shading or other window treatments. Currently, there are three main technologies for smart window applications: suspended particle displays (SPD), Polymer Dispersed Liquid Crystals (PDLCs), and electrochromics (ECs).

One drawback of conventional PDLCs or conventional mode devices is that the window becomes transparent only when a voltage is applied, and it becomes opaque when the power is off. Opaque windows are not desirable in applications where visibility through the window would enhance safety, for example, when there is loss of power in an emergency situation, such as a vehicle or aircraft crash or in a building fire. For electrochromic windows, the application of a voltage is usually needed to trigger a change in the window characteristics, even though it may not require maintaining dimming. In order to have a transparent window, advances have been made to create reverse mode devices such as Reverse Mode PDLSs, or PDLCs that are transparent when the power is off.

### SUMMARY

One way of creating reverse mode PDLCs is to use liquid crystal nematic compounds and aligning them in such a way that they are transparent in the off-state current (in other words, when the power is off).

To meet demands for low driving voltage, there is an increased need for new improved liquid crystal materials having high magnitudes of dielectric anisotropy to enable enhanced operation of reverse mode smart windows with low driving voltages.

The current disclosure describes a new liquid crystal (LC) composition, a polymer dispersed liquid crystal (PDLC) element comprising the liquid crystal composition, a selectively dimmable device comprising the PDLC element, and methods of manufacturing the device. These new materials can be used in reverse mode PDLC dimmable devices. The materials can be integral to a window or applied as a coating to provide a dimming capability for privacy and other purposes.

In some embodiments, the liquid crystal composition can comprise a heterocyclic compound. In some embodiments, the heterocyclic compounds can comprise a heterocyclic five-membered ring. In some embodiments, the heterocyclic compound can comprise a disubstituted moiety with a central linkage, such as:

A-Z—B,

wherein A can be an optionally substituted hydrocarbylthiophene, an optionally substituted hydrocarbylthiazole, an optionally substituted hydrocarbylthiadiazole, or an optionally substituted cyclopentane; B can be an optionally substituted biphenyl, such as 1,1′-biphenyl-4-yl and Z can be, —C≡C—, —CH═N—, —N═CH—, —CH₂—NH—, —NH—CH₂—, —C(O)O—, —OC(O)—, —NH—C(O)—, —C(O)—NH—, —O—, —NH—C(O)—NH—, or a bond.

For some compositions, the compound can be represented by Formula 1:

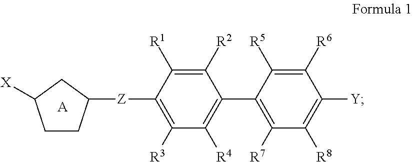

wherein R¹ thru R⁸ and Y are independently H, halogen, or another substituent; A is a heterocyclic aromatic ring structure, such as thiazole-2,4-diyl, thiazole-2,5-diyl, 1,2,4-thiadiazole-3,5-diyl, 1,3,5-thiadiazole-2,5-diyl, and thiophen-2-yl; Z is —C≡C—, —CH═N—, —N═CH—, —CH₂—NH—, —NH—CH₂—, —C(O)O—, —OC(O)—, —NH—C(O)—, —C(O)—NH—, —O—, —NH—C(O)—NH—, or a bond; and X is an optionally substituted hydrocarbyl, such as C₃₋₈ hydrocarbyl or C₂₋₇ hydrocarbyloxy. When the heterocyclic ring contains a sulfur atom, the substituents X and Z are present at the carbon atoms of the ring adjacent to the sulfur atom.

Some embodiments include a liquid crystal composition comprising a first liquid crystalline compound represented by Formula 2:

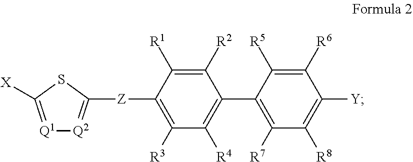

wherein R¹ through R⁸ can be independently H, F, Cl, Br, —CN or —NCS; Q¹ and Q² can independently be a substituted carbon atom, CH, or N; X can be C₃₋₈ hydrocarbyl or C₂₋₇ hydrocarbyloxy; Y can be H or F; and Z can be, —C≡C—, —CH═N—, —N═CH—, —CH₂—NH—, —NH—CH₂—, —C(O)O—, —OC(O)—, —NH—C(O)—, —C(O)—NH—, —O—, —NH—C(O)—NH—, or a bond.

Some embodiments include a liquid crystal mixture comprising the first liquid crystalline compound (e.g. a compound represented by Formula 2), further comprising a second liquid crystalline, such as a compound of the formula:

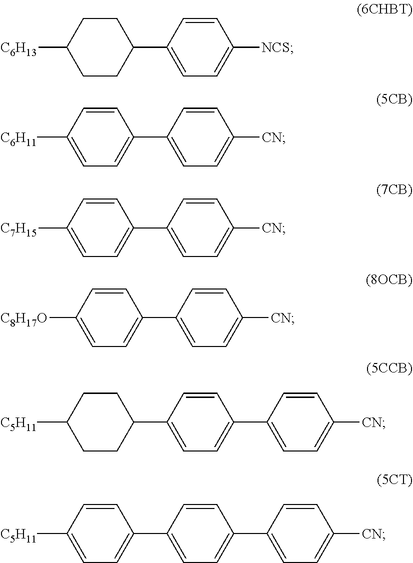

or any combination thereof.

Some embodiments include a polymer dispersed liquid crystal (PDLC) composition comprising: the liquid crystal mixture described herein and a polymer.

Some embodiments include a method of preparing the PDLC composition described herein, comprising the steps of: a) combining the liquid crystalline mixture with the polymer precursor LC-242, the chiral dopant, and the photoinitiator; b) mixing the resulting composition with an ultrasonic homogenizer; and c) warming the resulting mixture at 100° C. for 5 minutes on a hot plate.

Some embodiments include a liquid crystal element, the element comprising: a transparency changing layer, comprising a PDLC composition described herein, disposed between a first alignment layer and a second alignment layer.

Some embodiments include a selectively dimmable device comprising: a liquid crystal element described herein disposed between a first conductive substrate; and a voltage source; wherein the first conductive substrate, the second conductive substrate, and the element are in electrical communication with the voltage source such that when a voltage is applied from the voltage source, an electric field is generated across the liquid crystal element.

These and other embodiments are described in greater detail below.

### BRIEF DESCRIPTION OF THE DRAWINGS

FIG. 1A is a depiction of a liquid crystal element having a liquid crystal with positive dielectric anisotropy.

FIG. 1B is a depiction of a liquid crystal element having a liquid crystal with negative dielectric anisotropy.

FIG. 2 is a depiction of an embodiment of a selectively dimmable device with a positive dielectric anisotropic polymer dispersed liquid crystal.

FIG. 3 is a depiction of an embodiment of a selectively dimmable device with a negative dielectric anisotropic polymer dispersed liquid crystal.

FIG. 4 is yet another embodiment of a selectively dimmable device where the device comprises of a flexible film. Such a film may be used alone or may be applied on existing windows.

FIG. 5 is a plot showing haze results between the fabricated dimmable device embodiments.

FIG. 6 is a plot comparing the driving voltage of the dimmable device embodiments at on state or light scatter state.

### DETAILED DESCRIPTION

As used herein, the term “C_{X-Y}” refers to a carbon chain having from X to Y carbon atoms. For example, C₃₋₈ hydrocarbyl includes hydrocarbyl or cyclohydrocarbyl containing 3, 4, 5, 6, 7, or 8 carbon atoms.

The term “hydrocarbyl” as used herein refers to a moiety comprising carbon and hydrogen, wherein the carbon atoms are connected by single, double and/or triple bonds, or any combination thereof. A hydrocarbyl may be linear, branched, cyclic, or a combination thereof, and contain from one to thirty-five carbon atoms. Hydrocarbyl may be aromatic in nature. Examples of hydrocarbyl groups include but are not limited to C₃ alkyl; C₄ alkyl, such as —(CH₂)₃CH₃; C₅ alkyl, such as —(CH₂)₄CH₃; C₆ alkyl such as cyclohexyl or —(CH₂)₅CH₃; C₆ aryl such as phenyl; C₇ alkyl; C₈ alkyl; etc.

The term “alkyl” as used herein refers to a moiety comprising carbon and hydrogen, wherein the carbon atoms are connected by single bonds only, although the structure may be linear, branched, cyclic or any combination thereof, and may contain from one to thirty-five atoms.

The term “bond” for element Z as used herein, refers to a structure where Z in the formula A-Z—B represents a bond that connects the thiazole or thiophene structure (A) to the biphenyl structure (B), as shown below:

A-B.

The terms nematic, sematic, isotropic all having meanings common to those used by persons skilled in the art when referring to liquid crystal phases.

The terms “liquid crystal”, “liquid crystalline”, “liquid-crystal” and “liquid-crystalline” are identical descriptions for the individual molecule in this disclosure, as well as the mixtures of the individual compounds in this disclosure.

The current disclosure describes a liquid crystal composition, a polymer dispersed liquid crystal (PDLC) element, and a selectively dimmable device based on the aforementioned element.

### Liquid Crystal Composition

The liquid crystal compositions described herein include a liquid-crystalline mixture dispersed within a polymer. In some embodiments, the liquid crystal composition can comprise one or more liquid crystal compounds. In some embodiments, the liquid crystal composition can comprise two, three, four, five, six, seven or more liquid crystal compounds. In some embodiments, the liquid crystal composition can exhibit a mesogenic liquid crystal phase. In some embodiments, the liquid crystal composition can comprise a compound with positive dielectric anisotropy. Upon application of an electric field, the positive charge is displaced to one end of the molecule and the negative charge to the other end, thus creating an induced dipole moment. This results in the alignment of the longitudinal axis of liquid crystal molecules mutually parallel to the electric field direction. In some embodiments, the liquid crystal composition can comprise a compound with negative dielectric anisotropy, where the liquid crystal aligns perpendicular to the electric field. The index of refraction is larger along the long axis of the molecules than perpendicular to it. The optical and dielectric anisotropies of liquid crystals enable the index of refraction to be controlled electrically. In some embodiments, the liquid crystal composition can comprise both a compound with positive dielectric anisotropy and a compound with negative dielectric anisotropy.

### Polymer

Any suitable polymer can be used in a liquid crystal composition, and the polymer may be prepared by any suitable process known within the art, such as by polymerization of one or more polymer precursors, e.g., a monomer, an oligomer, or a combination thereof, may be polymerized in situ. The choice of polymer and the polymer preparation method is not intended to be limiting to the present disclosure.

In some embodiments, an initiator can be used in the polymerization of a polymer precursor. In some embodiments, the polymer can be a photopolymer. In some embodiments, the photopolymer can be formed by reacting a polymer precursor in the presence of a photoinitiator. In some embodiments, the polymer can be a thermoplastic polymer. In some embodiments, the thermoplastic polymer can be formed by reacting a polymer precursor in the presence of a thermal initiator. In some embodiments, the photopolymer can comprise a UV-curable polymer or a visual light based photopolymer. In some embodiments, the polymer can comprise a combination of a thermoplastic polymer and a photo/UV curable polymer.

Any suitable weight ratio of liquid crystal compound to polymer may be used, such as about 25:1 (e.g., 25 mg of liquid crystal to 1 mg or polymer) to about 1:1, about 14:1 to about 3:1, about 34:1, to about 5:1, about 5:1 to about 6:1, about 6:1 to about 7:1, about 7:1 to about 8:1, about 8:1 to about 9:1, about 9:1 to about 10:1, about 10:1 to about 11:1, about 11:1 to about 12:1, about 12:1 to about 14:1, about 14:1 to about 20:1, about 11:1 to about 8:1, or about 10:1.

A polymerization reaction may be carried out in the presence of an initiator, such as a photoinitiator or a thermal initiator. In some embodiments, the photoinitiator can comprise a UV irradiation photoinitiator. In some embodiments, the photoinitiator can also comprise a co-initiator, such as an α-alkoxydeoxybenzoin, α,α-dialkyloxydeoxybenzoin, α,α-dialkoxyacetophenone, α,α-hydroxyalkyphenone, O-acyl α-oximinoketone, dibenzoyl disulphide, S-phenyl diphenylsulphone, 4-morpholino-α-dialkylaminoacetophenone and combinations thereof. In some embodiments, the photoinitiator can comprise Irgacure® 184, Irgacure® 369, Irgacure® 500, Irgacure® 651, Irgacure® 907, Irgacure® 1117, Irgacure® 1700, Irgacure® TPO ((2,4,6-trimethylbenzoyldiphenylphosphine oxide), Irgacure® TPO-L (2,4,6-trimethylbenzoylphenylphosphinate), 4,4′-bis(N,N-dimethylamino)benzophenone (Michler's ketone), (1-hydroxycyclohexyl)phenyl ketone, 2,2-diethoxyacetophenone (DEAP), benzoin, benzyl, benzophenone, R-811 or combination thereof. In some embodiments, co-initiators can comprise N-phenylglycine, triethylamine, thiethanolamine and combinations thereof. In some embodiments, co-initiators may be employed to control the curing rate of the original pre-polymer such that material properties may be manipulated. In some embodiments, the photoinitiator can comprise an ionic photoinitator. In some embodiments, the ionic photoinitiator can comprise a benzophenone, camphorquinone, fluorenone, xanthone, thioxanthone, benzyls, α-ketocoumarin, anthraquinone, terephthalophenone, and combinations thereof. In some embodiments, the photoinitator can comprise Irgacure® 651. In some embodiments, the photoinitiator can comprise Irgacure®907. In some embodiments, the photoinitiator can comprise Irgacure® TPO.

In some embodiments, the thermal initiator can comprise: 4,4′-Azobis(4-cyanovaleric acid) (ACVA); α,α-azobisisobutyronitrile; 1,1′-azobis(cyclohexanecarbonitrile) (ACHN); ammonium persulfate; hydroxymethanesulfinic acid monosodium salt dihydrate (sodium formaldehydesulfoxylate); potassium persulfate; sodium persulfate; tert-butyl hydroperoxide; tert-butyl peracetate; cumene hydroperoxide; 2,5-di(tert-butylperoxy)-2,5-dimethyl-3-hexyne; dicumyl peroxide; 2,5-bis(tert-butylperoxy)-2,5-dimethylhexane (Luperox® 101, Luperox® 101XL45); 2,4-pentanedione peroxide (Luperox® 224); 1,1-bis(tert-butylperoxy)-3,3,5-trimethylcyclohexane (Luperox® 231); 1,1-bis(tert-butylperoxy)cyclohexane (Luperox® 331M80, Luperox® 531M80); benzoyl peroxide (Luperox® A98, Luprox® AFR40, Luperox® ATC50); butanone peroxide (Luperox® DDM-9, Luprox® DHD-9); tert-butyl peroxide (Luperox® DI); lauroyl peroxide (Luperox® LP); tert-butyl peroxybenzoate (Luperox® P); tert-butylperoxy 2-ethylhexyl carbonate (Luperox® TBEC); tert-butyl hydroperoxide (Luperox® TBH70X), or combinations thereof.

### Liquid-Crystalline Mixture

A liquid crystalline mixture can contain a single liquid crystalline compound, or can contain a first liquid crystalline compound, and can additionally contain one or more additional liquid crystalline compounds, e.g., a second liquid crystalline compound, a third liquid crystalline compound, etc. In some embodiments, the liquid crystal mixture can exhibit a mesogenic liquid crystal phase.

### First Liquid Crystalline Compound

Any suitable liquid crystalline compound can be used as the first liquid-crystalline compound. In some embodiments, the first liquid crystalline compound can comprise a heterocyclic compound. In some embodiments, the heterocyclic compound can comprise a heterocyclic five-membered ring. In some embodiments, the heterocyclic compound can comprise a disubstituted moiety with a central linkage, such as:

A-Z—B,

wherein A can be an optionally substituted hydrocarbylthiophene, an optionally substituted hydrocarbylthiazole, or an optionally substituted hydrocarbylthiadiazole, or an optionally substituted thiophene; B can be an optionally substituted biphenyl, such as 1,1′-biphenyl-4-yl and Z can be an ethylene (—H₂C—CH₂—), an ethenylene (—HC═CH—), an ethynylene (—C≡C—), —CH═N—, —N═CH—, —CH₂—NH—, —NH—CH₂—, —C(O)O—, —OC(O)—, —C(O)—NH—, —NH—C(O)—, —O—, —NH—C(O)—NH—, or a bond (e.g. so that A-B is the structure).

For the purposes of this disclosure, the following definitions apply for element Z: —CH═N— is equivalent to

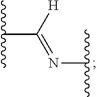 [SMILES: */C=N/*]

N; —N═CH— is equivalent to

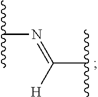 [SMILES: */C=N/*]

—CH₂—NH— is equivalent to

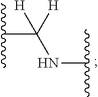 [SMILES: *CN*]

—NH—CH₂— is equivalent to

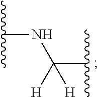 [SMILES: *CN*]

—C(O)O— is equivalent to

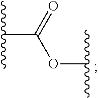 [SMILES: *OC(*)=O]

—OC(O)— is equivalent to

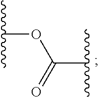 [SMILES: *OC(*)=O]

—C(O)—NH— is equivalent to

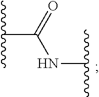 [SMILES: *NC(*)=O]

—NH—C(O)— is equivalent to

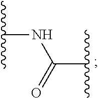 [SMILES: *NC(*)=O]

—O— is equivalent to

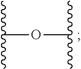 [SMILES: *O*]

and —NH—C(O)—NH— is equivalent to

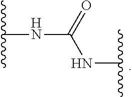 [SMILES: *NC(=O)N*]

In some embodiments, the compound can be represented by Formula 1:

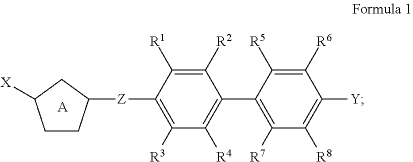

wherein R¹ through R⁸ and Y are independently H, F, Cl, Br, —CF₃, —CN or —NCS; A is thiazole-2,4-diyl, thiazole-2,5-diyl, 1,2,4-thiadiazole-3,5-diyl, 1,3,5-thiadiazole-2,5-diyl, and thiophen-2-yl; X is an optionally substituted hydrocarbyl, such as C₃₋₈ hydrocarbyl or C₂₋₇ hydrocarbyloxy; and Z is an ethylene (—H₂C—CH₂—), an ethenylene (—HC═CH—), an ethynylene (—C≡C—), —CH═N—, —N═CH—, —CH₂—NH—, —NH—CH₂—, —C(O)O—, —OC(O)—, —C(O)—NH—, —NH—C(O)—, —O—, —NH—C(O)—NH—, or a bond.

For some examples, the first liquid crystalline compound can be represented by Formula 2:

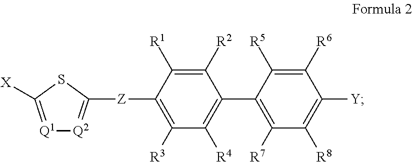

wherein R¹ through R⁸ and Y are independently H, F, Cl, Br, —CF₃, —CN or —NCS; Q¹ and Q² are independently a substituted carbon atom, CH, or N; X is C₃₋₈ hydrocarbyl or C₂₋₇ hydrocarbyloxy; and Z is —CH═N—, —N═CH—, —CH₂—NH—, or —NH—CH₂—.

In some examples, the first liquid crystalline compound can be represented by any one of the following Formulae 3A, 3B, 4A, or 4B:

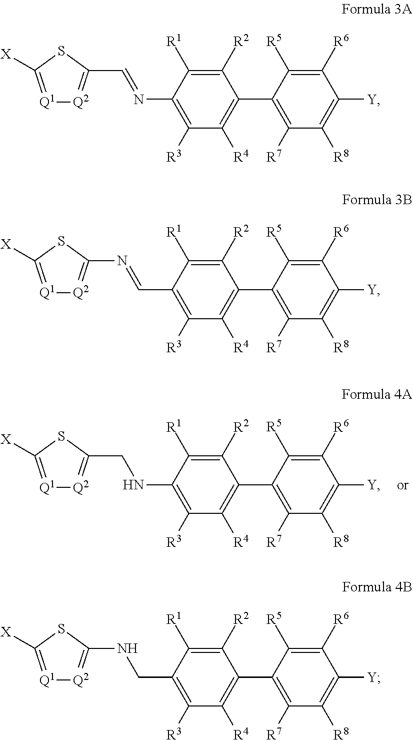

wherein R¹ through R⁸ can be H or F; Q and Q² are independently a substituted carbon atom, CH, or N; Y can be F, Cl, —CN or H; and X can be C₃₋₈ hydrocarbyl such as

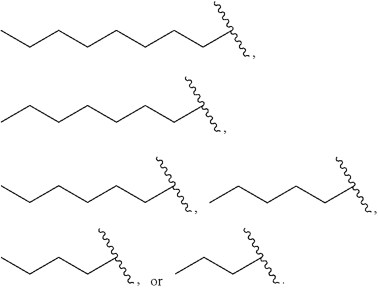

In some embodiments, the first liquid crystalline compound can be selected from the following:

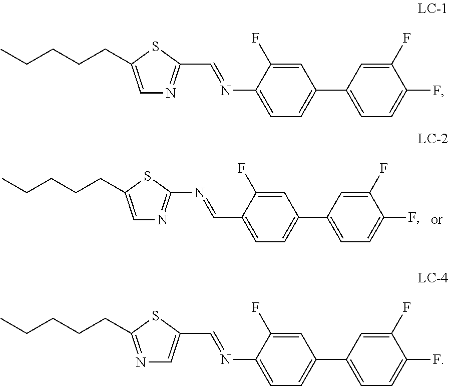 [SMILES: CCCCCc1cnc(/C=N/c2ccc(-c3ccc(F)c(F)c3)cc2F)s1 ; CCCCCc1cnc(/N=C/c2ccc(-c3ccc(F)c(F)c3)cc2F)s1 ; CCCCCc1ncc(/C=N/c2ccc(-c3ccc(F)c(F)c3)cc2F)s1]

In some embodiments of the disclosure, the first liquid crystalline compound can be represented by Formula 2, wherein R¹ thru R⁸ and Y are independently H, F, C, Br, —CF₃, —CN or —NCS; Q¹ and Q² are independently a substituted carbon atom, CH, or N; X is C₃₋₈ hydrocarbyl or C₂₋₇ hydrocarbyloxy; and Z is —C(O)O—, —OC(O)—, —NH—C(O)—, or —C(O)—NH.

In some examples of the disclosure, the compound can be represented by any one of the following Formulae 5A, 5B, 6A, or 6B:

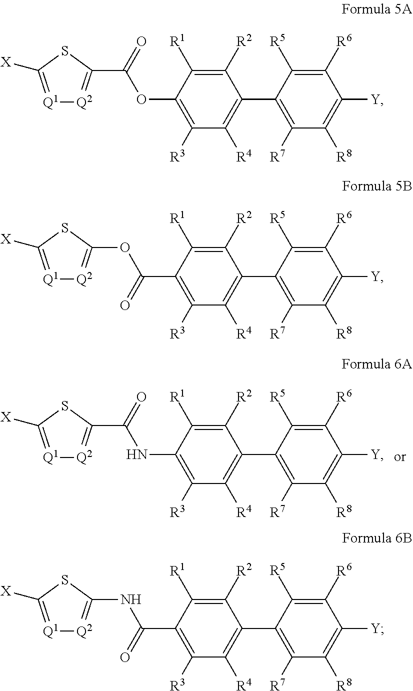

wherein R¹ through R⁸ can be H or F; Q¹ and Q² are independently a substituted carbon atom, CH, or N; Y can be F, Cl, —CN or H; and X can be C₃₋₈ hydrocarbyl such as

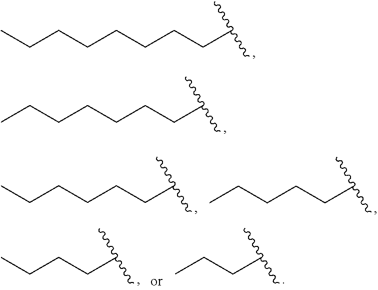

In some embodiments, the compound can be selected from the following:

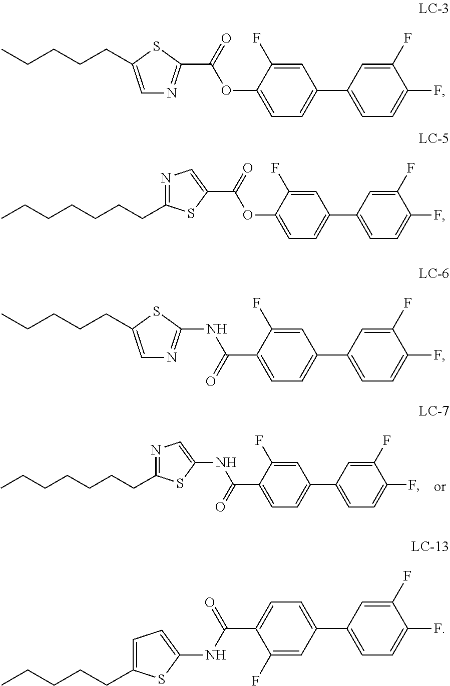 [SMILES: CCCCCc1cnc(C(=O)Oc2ccc(-c3ccc(F)c(F)c3)cc2F)s1 ; CCCCCCCc1ncc(C(=O)Oc2ccc(-c3ccc(F)c(F)c3)cc2F)s1 ; CCCCCc1cnc(NC(=O)c2ccc(-c3ccc(F)c(F)c3)cc2F)s1 ; CCCCCCCc1ncc(NC(=O)c2ccc(-c3ccc(F)c(F)c3)cc2F)s1 ; CCCCCc1ccc(NC(=O)c2ccc(-c3ccc(F)c(F)c3)cc2F)s1]

In some embodiments, the first liquid crystalline compound can comprise a compound represented by formula 7:

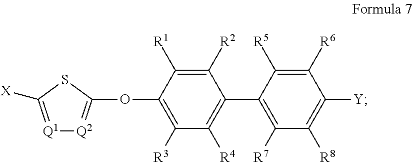

wherein R¹ through R⁸ can be H or F; Q¹ and Q² are independently a substituted carbon atom, CH, or N; Y can be F, Cl, —CN or H; and X can be C₃₋₈ hydrocarbyl such as

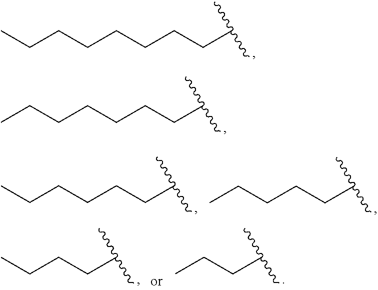

In some embodiments, the compound can be the following:

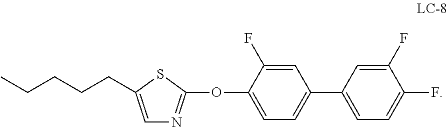 [SMILES: CCCCCc1cnc(Oc2ccc(-c3ccc(F)c(F)c3)cc2F)s1]

In some embodiments, the first liquid crystalline compound can be represented by Formula 2, wherein R¹ thru R⁸ and Y are independently H, F, Cl, Br, —CF₃, —CN or —NCS; Q¹ and Q² are independently a substituted carbon atom, CH, or N; and X is C₃₋₈ hydrocarbyl or C₂₋₇ hydrocarbyloxy; and Z is —NH—C(O)—NH—.

In some embodiments, the first liquid crystalline compound can comprise a compound represented by Formula 8:

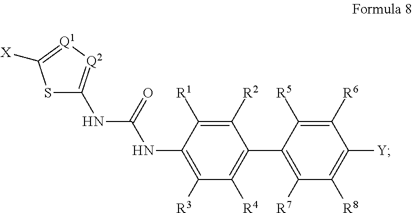

wherein R¹ through R⁶ can be H or F; Q¹ and Q² are independently a substituted carbon atom, CH, or N; X can be a C₃₋₈ alkyl; Y can be F, Cl, —CN or H; and X can be C₃₋₈ hydrocarbyl such as

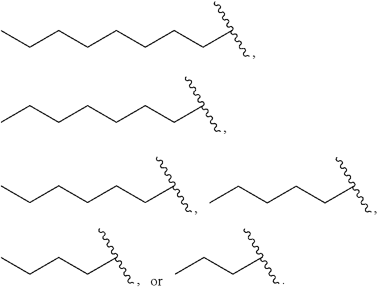

In some embodiments, the compound can comprise a compound selected from the following:

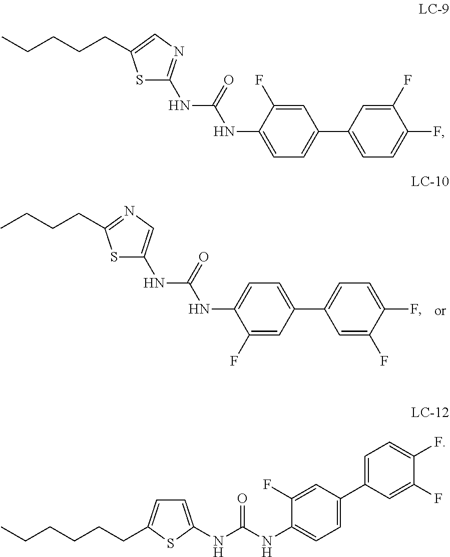 [SMILES: CCCCCc1cnc(NC(=O)Nc2ccc(-c3ccc(F)c(F)c3)cc2F)s1 ; CCCCc1ncc(NC(=O)Nc2ccc(-c3ccc(F)c(F)c3)cc2F)s1 ; CCCCCCc1ccc(NC(=O)Nc2ccc(-c3ccc(F)c(F)c3)cc2F)s1]

In some embodiments, the first liquid crystalline compound can comprise a compound represented by Formula 9:

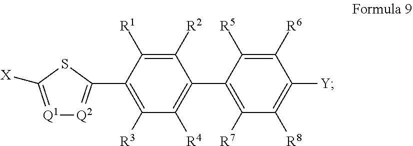

wherein R¹ through R⁸ can be H or F; Q and Q² are independently a substituted carbon atom, CH, or N; Y can be F, Cl, —CN or H; and X can be C₃₋₈ hydrocarbyl such as

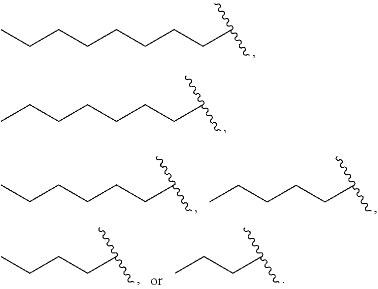

In some embodiments, the composition can comprise:

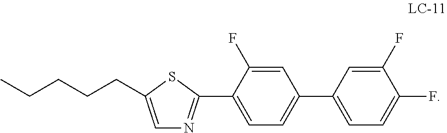 [SMILES: CCCCCc1cnc(-c2ccc(-c3ccc(F)c(F)c3)cc2F)s1]

In some embodiments, the liquid crystal composition can comprise a positive dielectric anisotropic composition. In some embodiments, the first liquid crystal composition can comprise a compound represented by:

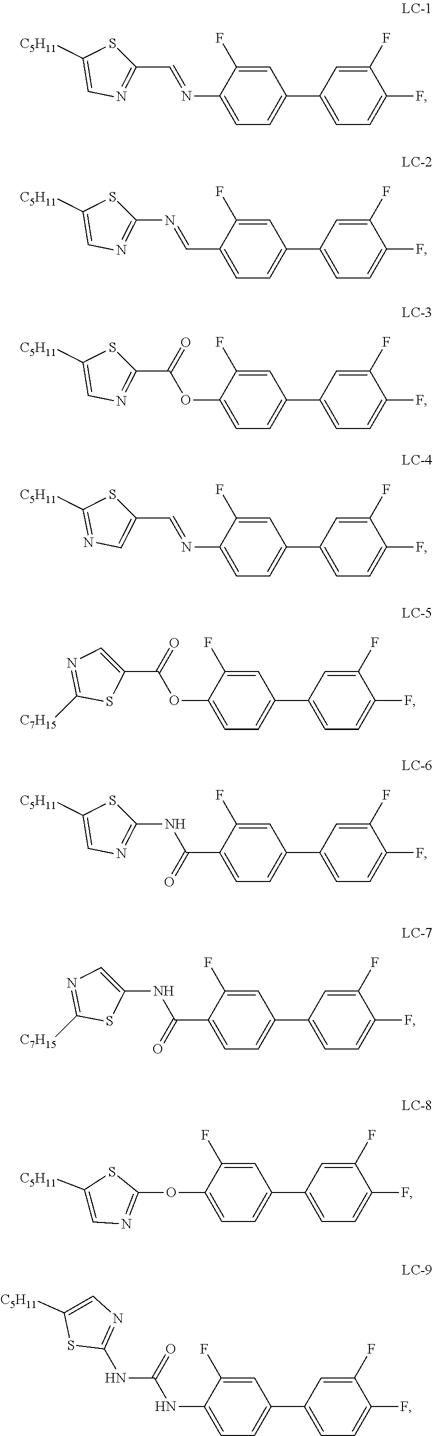

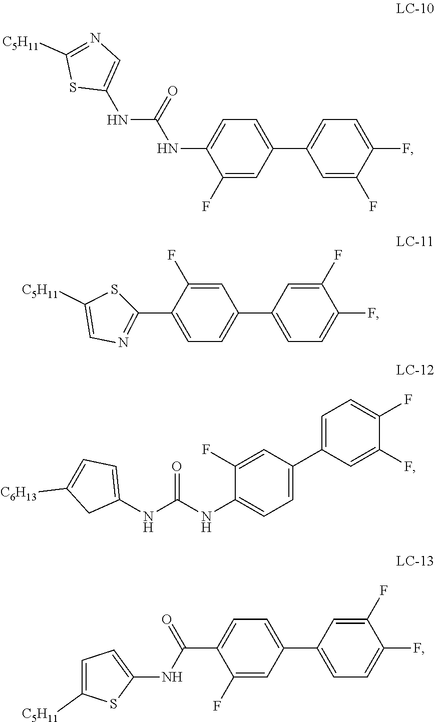

or any combination thereof.

Any suitable amount of the first liquid crystalline compound may be used in the liquid crystalline mixture. In some embodiments, the mass percentage of the first liquid crystalline compound can be in a range of about 1 wt % to about 20 wt %, in total based upon the total weight percentage of the liquid crystalline mixture that is equal to 100%. In some examples, the first liquid crystalline compound can be in a range of 0.5-1.0 wt %, about 1-2 wt %, about 2-3 wt %, about 3-4 wt %, about 4-5 wt %, about 5-6 wt %, about 6-7 wt %, about 7-8 wt %, about 8-9 wt %, about 9-10 wt %, about 10-11 wt %, about 11-12 wt %, about 12-13 wt %, about 13-14 wt %, about 14-15 wt %, about 15-16 wt %, about 17-18 wt %, about 18-19 wt %, about 19-20 wt %, about 4.5 wt %, about 4.6 wt %, about 4.7 wt %, about 4.8 wt %, about 4.9 wt %, about 5.0 wt % about 5.1 wt %, about 5.2 wt %, about 5.3 wt %, about 5.4 wt %, about 5.5 wt %, about 5.6 wt %, about 5.7 wt %, or about 5.8 wt % with respect to the total mass of the liquid crystalline mixture.

### Second Liquid-Crystalline Compound

Additional liquid crystalline compounds in a liquid crystalline mixture may be designated as a second liquid crystalline compound, a third liquid crystalline compound, a fourth liquid crystalline compound, a fifth liquid crystalline compound, etc., or any combination thereof.

Some embodiments include a nematic liquid crystalline mixture. The mixture can comprise an additional liquid crystalline compound such as a second liquid crystalline compound, a third liquid crystalline compound, a fourth liquid crystalline compound, etc.

In some embodiments, the additional liquid crystalline compound can be a nematic compound exhibiting positive dielectric anisotropy. In some embodiments, the additional liquid crystalline compound can be a nematic compound with a negative dielectric anisotropy.

Other embodiments can include an additional liquid crystalline compound represented by Formula 10.

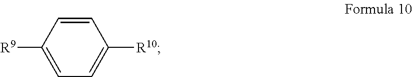

wherein R⁹ is substituted phenyl, substituted cyclohexane, substituted biphenyl, or substituted cyclohexyl-benzene; and R¹⁰ is C₁₋₆ hydrocarbyl, C₁₋₆ hydrocarbyloxy, —CN, —NCS, F, Cl, OH, NO₂, —NR^{a}R^{b}, —NHCOR^{a}, —NHSO₂R^{a}, —OCOR^{a}, or —SO₂R^{a}; —C(O)R^{a}, —C(O)OR^{a}, —C(O)NHR^{a}, or —C(O)NR^{a}R^{b}; and R^{a} and R^{b} can be independently H or optionally substituted C₁₋₆ hydrocarbyl.

With respect to any relevant structural representation, such as Formula 10, R⁹ can be a substituted phenyl, substituted cyclohexane, substituted biphenyl, or substituted cyclohexyl-benzene. In some embodiments, R⁹ can be:

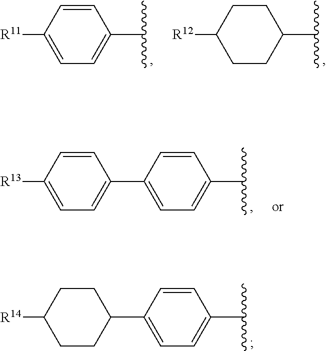

wherein R¹¹, R¹², R¹³ and R¹⁴ can be independently a hydrocarbyl, a hydrocarbyloxy, or any substituent. In some embodiments, R¹¹, R¹², R¹³ and R¹⁴ can be independently a C₃₋₉ hydrocarbyl or C₃₋₉ hydrocarbyloxy. In some embodiments, R¹¹, R¹², R¹³ or R¹⁴ can be C₃₋₉ alkyl, such as C₃ alkyl, C₄ alkyl, C₅ alkyl, C₆ alkyl, or C₇ alkyl. In some embodiments, R¹¹, R¹², R¹³ or R¹⁴ can be C₃₋₉ alkoxy, such as C₈ alkoxy.

With respect to any relevant structural representation, such as Formula 10, R¹⁰ can be C₁₋₆ alkyl, C₁₋₆ alkyloxy, —CN, —NCS, F, C, OH, NO₂, —NR^{a}R^{b}, —NHCOR^{a}, —NHS₂R^{a}, —OCOR^{a}, or —SO₂R^{a}; —C(O)R^{a}, —C(O)OR^{a}, —C(O)NHR^{a}, or —C(O)NR^{a}R^{b}. In some embodiments, R¹⁰ can be —CN or —NCS. In some embodiments, R¹⁰ can be —CN. In some embodiments, R¹⁰ can be —NCS.

In some representations of the disclosure, the liquid crystal compounds of Formula 10 that are used in the liquid crystalline mixtures can be selected from the group consisting of:

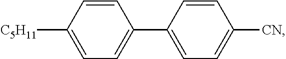

4′-pentyl-[1,1′-biphenyl]-4-carbonitrile (5CB);

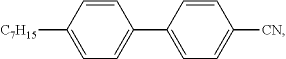

4′-heptyl-[1,1′-biphenyl]-4-carbonitrile (7CB);

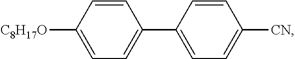

4′-(octyloxy)-[1,1′-biphenyl]-4-carbonitrile (80CB);

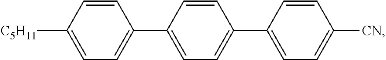

4″-pentyl-[1,1′:4′,1″-terphenyl]-4-carbonitrile (5CT);

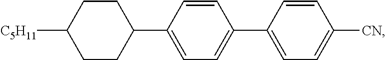

4′-(4-pentylcyclohexyl)-[1,1′-biphenyl]-4-carbonitrile (5CCB),

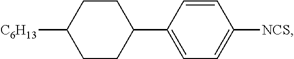

4-hexyl-4′-isothiocyanato-1,1′-biphenyl (6CHBT), or any combination thereof.

In some examples, the liquid crystal mixture can comprise the aforementioned liquid crystal compositions of Formulae 1 through 9 and one or more compounds of Formula 10 such as 5CB, 7CB, 80CB, 5CT, 5CCB, or 6CHBT.

In some instances of the disclosure, the mass percentage of the individual compounds in the mixture are chosen such that the total weight percentage of the liquid crystal mixture is equal to 100 wt %.

In some embodiments of the disclosure, the mass percentage of 5CB can be about 0 wt % to about 60 wt %, such as about 1-10 wt %, about 10-20 wt %, about 20-25 wt %; about 25-30 wt %, about 30-34 wt %, about 34-36 wt %; about 36-38 wt % about 38-40 wt %; about 40-41 wt %, about 41-42 wt %, or about 42-43 wt %, about 43-44 wt %, about 44-45 wt %, about 45-46 wt %, about 46-47 wt %. about 47-48 wt %, about 48-49 wt %, or about 49-50 wt %, about 50-51 wt %, a bout 51-54 wt %, a bout 54-57 wt % a bout 57-60 wt %, a bout 47.3 wt %, a bout 47.4 wt %, about 47.5 wt %, about 47.6 wt %, about 47.7 wt %, about 49.8 wt %, about 49.9 wt %, or about 50.0 wt % with respect to the total mass of the liquid crystalline mixture.

In some illustrations of the disclosure, the mass percentage of 7CB can be from about 0 wt % to about 25 wt %, such as about 0.1-1 wt %, about 1-2 wt %, or about 2-3 wt %; about 3-4 wt %, about 4-5 wt %, about 5-6 wt %; about 6-7 wt %, about 7-8 wt %, about 8-9 wt %; about 9-10 wt %, about 10-11 wt %, about 11-12 wt %; about 12-13 wt %, about 13-14 wt %, about 14-15 wt %, about 15-16 wt %, about 16-17 wt %. about 17-18 wt % about 18-19 wt %, about 19-20 wt % about 20-21 wt %, about 21-22 wt %, about 22-23 wt %, about 23-24 wt %, about 24-25 wt %; about 9 wt % to about 12 wt %, about 9.5 wt %, about 9.6 wt %, about 9.7 wt %, about 9.8 wt %, about 9.9 wt %, about 10.0 wt %, about 10.1 wt % about 10.2 wt %, about 10.3 wt %, about 10.4 wt %, about 10.5 wt %, about 10.6 wt %, about 10.7 wt %, about 10.8 wt %, or about 10.9 wt % with respect to the total mass of the liquid crystalline mixture.

In some occurrences, the mass percentage of 80CB can be in a range of about 0 wt % to about 10 wt %, such as about 0.1-0.5 wt %, about 0.5-1 wt %, about 1-2 wt %, about 2-3 wt %, about 3-4 wt %, about 4-5 wt %, about 5-6 wt %, about 6-7 wt %, about 7-8 wt %, about 8-9 wt %, about 9-10 wt %, about 4.7 wt %, about 4.8 wt %, about 4.9 wt %, about 5.0 wt % about 5.1 wt %, about 5.2 wt %, about 5.3 wt %, about 5.4 wt %, about 5.6 wt %, about 5.7 wt %, about 5.8 wt %, about 5.9 wt %, or about 6.0 wt % with respect to the total mass of the liquid crystalline mixture.

In some embodiments, the mass percentage of 5CT can be from about 0 wt % and about 16 wt %, such as about 8 wt % to about 12 wt %; about 0.1-1 wt %, about 1-2 wt %, or about 2-3 wt %; about 3-4 wt %, about 4-5 wt %, or about 5-6 wt %; about 6-7 wt %, about 7-8 wt %, or about 8-9 wt %; about 9-10 wt %, about 10-11 wt %, or about 11-12 wt %; about 12-13 wt %, about 13-14 wt %, about 14-15 wt %, about 15-16 wt %, about 9.0 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, or about 10 wt % with respect to the total mass of the liquid crystalline mixture.

For some liquid crystal mixtures of the disclosure, the mass percentage of 5CCB can be from 0 wt % to about 18 wt %, such as about 4.5 wt % to about 17 wt %; about 0.1-1 wt %, about 1-2 wt %, about 2-3 wt %; about 3-4 wt %, about 4-5 wt %, about 5-6 wt %; about 6-7 wt %, about 7-8 wt %, about 8-9 wt %; about 9-10 wt %, about 10-11 wt %, or about 11-12 wt %; about 12-13 wt %, about 13-14 wt %, about 14-15 wt %; about 15-16 wt %, about 16-17 wt %, about 17-18 wt %, about 13.5 wt %, about 13.6 wt %, about 13.7 wt %, about 13.8 wt %, about 13.9 wt %, about 14 wt %, about 14.1 wt %, about 14.2 wt %, about 14.3 wt %, about 14.4 wt %, about 14.5 wt %, about 14.6 wt %, about 14.7 wt %, about 14.8 wt %, about 14.9 wt %, or about 15 wt % with respect to the total mass of the liquid crystalline mixture.

In some cases, the mass percentage of 6CHBT can be about 0 wt % to about 25 wt %, such as about 0.1-1 wt %, about 1-2 wt %, or about 2-3 wt %; about 3-4 wt %, about 4-5 wt %, about 5-6 wt %; about 6-7 wt %, about 7-8 wt %, or about 8-9 wt %; about 9-10 wt %, about 10-11 wt %, about 11-12 wt %; about 12-13 wt %, about 13-14 wt %, about 14-15 wt %; about 15-16 wt %, about 16-17 wt %, about 17-18 wt %, about 18-19 wt %, about 19-20 wt %; about 8.3-12 wt %; about 20-25 wt %, about 9 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, or about 10 wt % with respect to the total mass of the liquid crystalline mixture.

### Chiral Dopant

A liquid crystal mixture may contain a chiral dopant. A chiral dopant may be useful to enhance haze by creating scattering centers. A chiral agent can create a helical configuration, which gives focal conic type alignment of liquid crystal under applied voltage and this gives rise to higher haze. Higher haze may be helpful for the application of privacy.

In some embodiments, the chiral dopant can comprise a di-benzoate based compound, such as (S)-octan-2-yl 4-((4-(hexyloxy)benzoyl)oxy)benzoate (S-811 or ZLI-0811), R-octan-2-yl 4-((4-(hexyloxy)benzoyl)oxy)benzoate (R-811 or ZLI-3786), (S)-1-phenylethane-1,2-diyl bis(4-(4-pentylcyclohexyl)benzoate) (S-1011 or ZLI-4571), or (R)-1-phenylethane-1,2-diyl bis(4-(4-pentylcyclohexyl)benzoate) (R-1011 or ZLI-4572), as shown below:

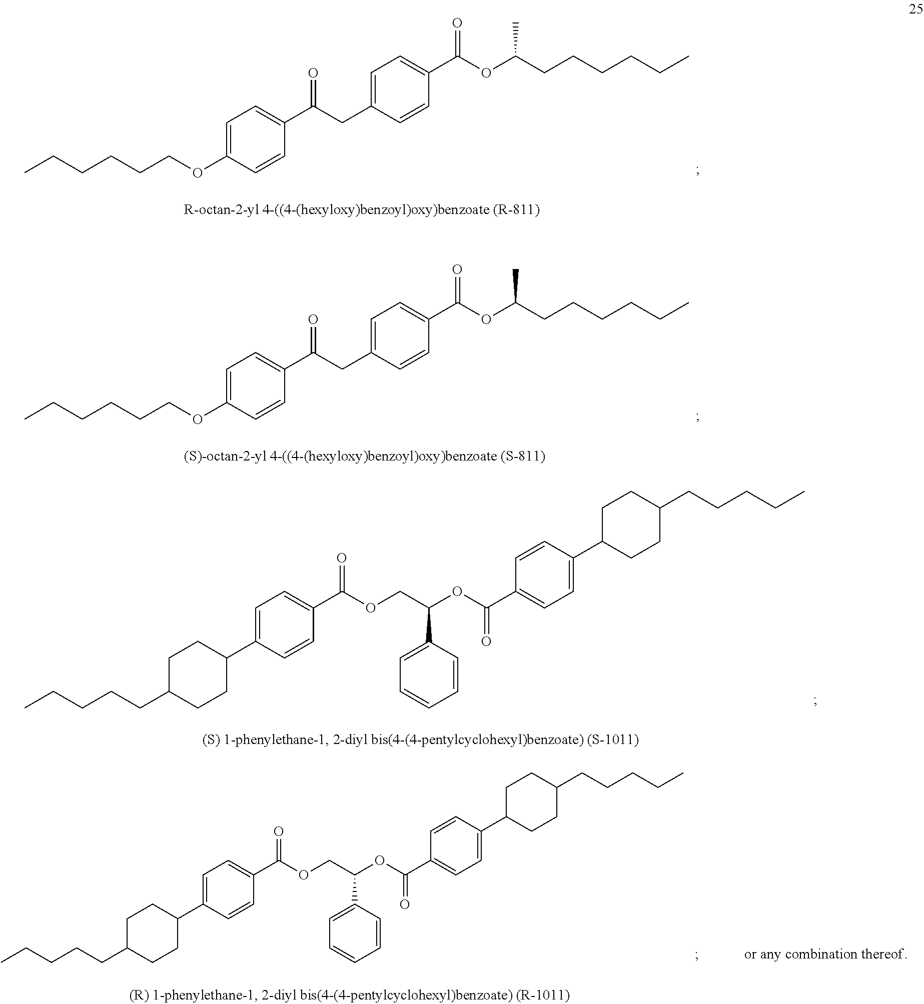

In some examples of the disclosure, the mass percentage of chiral dopant to the composition can be from about 0-10 wt %, about 0-5 wt %, about 0.1-1 wt %, about 1-2 wt %, about 2-2.5 wt %, about 2.5-3 wt %, or about 3-3.4 wt %; about 3.4-3.6 wt %, about 3.6-3.8 wt %, about 3.8-4 wt %; about 4-4.1 wt %. about 4.1-4.2 wt %, about 4.2-4.3 wt %, or about 4.3-4.4 wt %; about 4.4-4.5 wt %, about 4.5-4.6 wt %, or about 4.6-4.7 wt %; about 4.7-4.8 wt %, about 4.8-4.9 wt %, about 4.9-5 wt %, or about 5-5.2 wt %; about 5.2-5.4 wt %, about 5.4-5.7 wt %, or about 5.7-6 wt %; about 6-6.5-wt %, about 6.5-7 wt %, or about 7-8 wt %; about 8-9 wt %, about 9-10 wt %, about 0.5 wt %, about 0.6 wt % about 0.7 wt %, about 0.8 wt %, about 0.9 wt %, about 1 wt %, about 1.1 wt %, about 1.2 wt %, about 1.3 wt %, about 1.4 wt %, or about 1.5 wt %.

### Liquid Crystal Element

Typically, a liquid crystal element which comprises a transparency changing layer (also termed a transparency layer), and at least two alignment layers, such as a first alignment layer, and a second alignment layer. The transparency layer can further comprise a liquid crystalline composition described herein, and the transparency layer may have a first opposing surface and a second opposing surface on opposite sides of the transparency layer. In some embodiments, the transparency layer can be between the first alignment layer and the second alignment layer such that the first alignment layer is nearest to the first opposing surface and the second alignment layer is nearest to the second opposing surface. In some embodiments, the transparency changing layer's opposing surfaces are also the transparency changing layer's surfaces that have the greatest surface areas.

In addition to a liquid crystalline composition, a transparency layer may further comprise a spacer, a dispersant, a plasticizer, a binder, and/or solvents.

In some embodiments, a spacer can be used to control the thickness of the liquid crystal element (i.e. defining the gap between the two alignment layers and the conducting substrates). In some embodiments, the spacers provide structural support to ensure a uniform thickness of the liquid crystal element. In some embodiments, the spacers can be in the form of beads. In some embodiments, the spacers can comprise silica dioxide or glass, or a polymer, such as divinylbenzene, polymethylmethacrylate, polybutylmethacrylate, polymethylsilsesquioxane, polyurethane, polytetrafluoroethylene (Teflon), benzocyclobutene (BCB), amorphous fluoropolymer (Cytop), perfluorocyclobutene, or combinations thereof.

A spacer bead may have any appropriate diameter depending upon the desired spacing characteristics sought. For example, the beads may have an average diameter of about 1-60 μm, about 1-50 μm, about 1-5 μm, about 10 μm, about 15 μm, or to about 20 μm, to about 50 μm; about 1-2 μm, about 2-3 μm, about 3-4 μm, about 4-5 μm, about 5-6 μm, about 6-7 μm, about 7-8 μm, about 8-9 μm, or about 9-10 μm; about 10-11 μm, about 11-12 μm, about 12-13 μm, about 13-14 μm, about 14-15 μm, about 15-16 μm, about 16-17 μm, about 17-18 μm, about 18-19 μm, or about 19-20 μm; about 20-21 μm, about 21-22 μm, about 22-23 μm, about 23-24 μm, about 24-25 μm, about 25-26 μm, about 26-27 μm, about 27-28 μm, about 28-29 μm, or about 29-30 m; about 30-31 μm, about 31-32 μm, about 32-33 μm, about 33-34 μm, about 34-35 μm, about 35-36 μm, about 36-37 μm, about 37-38 μm, about 38-39 μm, or about 39-40 μm; about 40-41 μm, about 41-42 μm, about 42-43 μm, about 43-44 μm, about 44-45 μm, about 45-46 μm, about 46-47 μm, about 47-48 μm, about 48-49 μm, or about 49-50 μm; about 50-51 μm, about 51-52 μm, about 52-53 μm, about 53-54 μm, about 54-55 μm, about 55-56 μm, about 56-57 μm, about 57-58 μm, about 58-59 μm, or about 59-60 μm; or any combination thereof. In some embodiments the spacer can be dispersed in a random distribution. In some embodiments, the spacers can be dispersed uniformly. In some embodiments, the liquid crystal element can contain spacers with an average density ranging from about 10 spacers/in² to about 1000 spacers/in², or any combinations thereof.

An alignment layer, such as a first alignment layer or a second alignment layer, is a layer that helps to align a liquid crystalline compound. The alignment layer may be composed of any suitable alignment material, or a material that can help with this alignment. In some embodiments, the alignment layer can comprise a polyimide, such as LX-1400.

Some liquid crystals may have a positive dielectric anisotropy, negative dielectric anisotropy, or neutral dielectric anisotropy. In some embodiments, the liquid crystal mixture can comprise one or more compounds with positive dielectric anisotropy. In some embodiments, the liquid crystal mixture can comprise one or more compounds with negative dielectric anisotropy. In some embodiments, the liquid crystal mixture can comprise both a compound with positive dielectric anisotropy and a compound with negative dielectric anisotropy.

The dielectric anisotropy is related to dielectric properties as well as optical properties depending on the direction, either along the length of the molecule (or molecular axis), or perpendicular to the length of the molecule (or molecular axis). The dielectric properties depend on the molecular shape and substituent moieties and their locations on a given molecule.

Molecules with a positive dielectric anisotropy include molecules having a dielectric constant parallel to the length of the molecule that is greater than the dielectric constant perpendicular to the length of the molecule, where the length of a molecule is defined as the vector between the two farthest moieties. Molecules with a negative dielectric anisotropy include molecules having a dielectric constant perpendicular to the length molecule that is greater than the dielectric constant parallel to the length of the molecule. Molecules with a neutral dielectric anisotropy include molecules having dielectric constant perpendicular to the length molecule that is approximately the same as (e.g., a difference that is less than about 5% or less than about 1%) the dielectric constant parallel to the length of the molecule.

For liquid crystal mixtures having a positive dielectric anisotropy, the polyimide can be chosen to help liquid crystalline compounds to homogenously align with the alignment layer, or to be oriented roughly parallel to the alignment layer, when there is no voltage applied. For example, a polyimide may be chosen that has a low pre-tilt angle. The pre-tilt is the angle between a substrate containing the polyimide and the direction along the length of the liquid crystal compound(s) that results from the presence of the polyimide. For a transparency changing layer between two alignment layers, and having two opposing surfaces that are parallel to the two alignment layers, the pre-tilt angle will be approximately the angle between the surface of the alignment layer and the liquid crystalline compounds in the transparency changing layer.

For liquid crystal mixtures having a positive dielectric anisotropy, the homogenous alignment polyimide can compose a polyimide that has a pre-tilt angle of less than about 15 degrees; less than about 5 degrees; about 0.01-1 degrees, about 1-2 degrees, or about 2-3 degrees; about 3-4 degrees, about 4-5 degrees, or about 5-6 degrees; about 6-7 degrees, about 7-8 degrees, or about 8-9 degrees; about 9-10 degrees, about 10-11 degrees, or about 11-12 degrees; or about 12-13 degrees, about 13-14 degrees, or about 14-15 degrees. In some embodiments, the homogenous-alignment polyimide can comprise: AL3056, AL16301, AL17901, PI-2525, PI-2555, PI-2574, SE-141, SE-150, SE-4540, SE-6441, SE-7792, SE-8292, LX-1400, or combinations thereof.

For liquid crystal mixtures having a negative dielectric anisotropy, the polyimide can be chosen to help a liquid crystalline compound to homeotropically align with an alignment layer, or to be oriented perpendicularly to the alignment layer, when there is no voltage applied. For example, a polyimide may have a pre-tilt angle of about 85-90 degrees, about 75-76 degrees, or about 76-77 degrees; about 77-78 degrees, bout 78-79 degrees, or about 79-80 degrees; about 80-81 degrees, about 81-82 degrees, or about 82-83 degrees; about 83-84 degrees, about 84-85 degrees, or about 85-86 degrees; about 87-88 degrees, about 88-89 degrees, or about 89-90 degrees. In some embodiments, the homeotropic-alignment polyimide can comprise a polyimide that has a pre-tilt angle of about 90 degrees. In some embodiments, the homeotropic-alignment polyimide can comprise a polyimide selected form PI 1211, S60702, S659, SE1211, SE-5300, SE-5661, SE-150 or any combinations thereof.

In some embodiments, a liquid crystalline element is configured so that when a voltage is applied across the element, the liquid crystals will rotate from their pre-tilt positions in response to the application of an electric field. The change in orientation may result in a change of index of refraction due to the change in orientation of the individual molecules. The change in the liquid crystal index of refraction within the suspended liquid crystal droplets can result in an index of refraction mismatch between the droplets and the polymer. If the droplets are of an appropriate sixe the index of refraction mismatch and the polymer can result in a haze or loss of transparency in the liquid crystalline element due to light scatter.

In addition to an alignment material, an alignment layer may further comprise a dispersant, a plasticizer, binder and/or solvent.

In some embodiments, the liquid crystal element can also comprise a dispersant such as ammonium salts, e.g., NH₄Cl; Flowlen; fish oil; long chain polymers; steric acid; oxidized Menhaden Fish Oil (MFO); dicarboxylic acids such as but not limited to succinic acid, ethanedioic acid, propanedioic acid, pentanedioic acid, hexanedioic acid, heptanedioic acid, octanedioic acid, nonanedioic acid, decanedioic acid, o-phthalic acid, and p-phthalic acid; sorbitan monooleate; or a mixture thereof. In some embodiments, the dispersant can comprise oxidized MFO.

In some embodiments, the liquid crystal element can also comprise a plasticizer. A plasticizer can be type 1 plasticizer, that can generally decrease the glass transition temperature (T_{g}), e.g., makes it more flexible, phthalates (n-butyl, dibutyl, dioctyl, butyl benzyl, missed esters, and dimethyl); and type 2 plasticizers that can enable more flexible, more deformable layers, and perhaps reduce the amount of voids resulting from lamination, e.g., glycols (polyethylene; polyalkylene; polypropylene; triethylene; dipropylglycol benzoate).

Type 1 plasticizers can include, but are not limited to: butyl benzyl phthalate, dicarboxylic/tricarboxylic ester-based plasticizers such as but not limited to phthalate-based plasticizers such as but not limited to bis(2-ethylhexyl) phthalate, diisononyl phthalate, bis(n-butyl)phthalate, butyl benzyl phthalate, diisodecyl phthalate, di-n-octyl phthalate, diisooctyl phthalate, diethyl phthalate, diisobutyl phthalate, di-n-hexyl phthalate and mixtures thereof; adipate-based plasticizers such as but not limited to bis(2-ethylhexyl)adipate, dimethyl adipate, monomethyl adipate, dioctyl adipate and mixtures thereof; sebacate-based plasticizers such as but not limited to dibutyl sebacate, and maleate.

Type 2 plasticizers can include, but are not limited to: dibutyl maleate, diisobutyl maleate and mixtures thereof, polyalkylene glycols such as but not limited to polyethylene glycol, polypropylene glycol and mixtures thereof. Other plasticizers which may be used include but are not limited to benzoates, epoxidized vegetable oils, sulfonamides such as but not limited to N-ethyl toluene sulfonamide, N-(2-hydroxypropyl)benzene sulfonamide, N-(n-butyl)benzene sulfonamide, organophosphates such as but not limited to tricresyl phosphate, tributyl phosphate, glycols/polyethers such as but not limited to triethylene glycol dihexanoate, tetraethylene glycol diheptanoate and mixtures thereof; alkyl citrates such as but not limited to triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate, alkyl sulphonic acid phenyl ester, and mixtures thereof.

In some embodiments, the liquid crystal element can also comprise a binder. In some embodiments, an organic binder can be used. In some embodiments, an organic binder can comprise a vinyl polymer such as but not limited to polyvinyl butyral (PVB), polyvinyl alcohol (PVA), polyvinyl chloride (PVC), polyvinyl acetate (PVAc), polyacrylonitrile, and mixtures thereof or a copolymer thereof; polyethyleneimine; poly methyl methacrylate (PMMA); vinyl chloride-acetate; and mixtures thereof. In some embodiments, the organic binder can comprise PVB.

In some embodiments, the liquid crystal element can also comprise a solvent as part of the method of synthesizing the element. In some embodiments, the solvent can comprise a polar solvent, such as water or tetrahydrofuran (THF). In some embodiments, the polar solvent can comprise THF. In some embodiments, the non-polar solvent may include, but is not limited to, a lower alkanol such as but not limited to ethanol, methanol isopropyl alcohol, xylenes, cyclohexanone, acetone, toluene and methyl ethyl ketone, and mixtures thereof. In some embodiments, the non-polar solvent may be toluene.

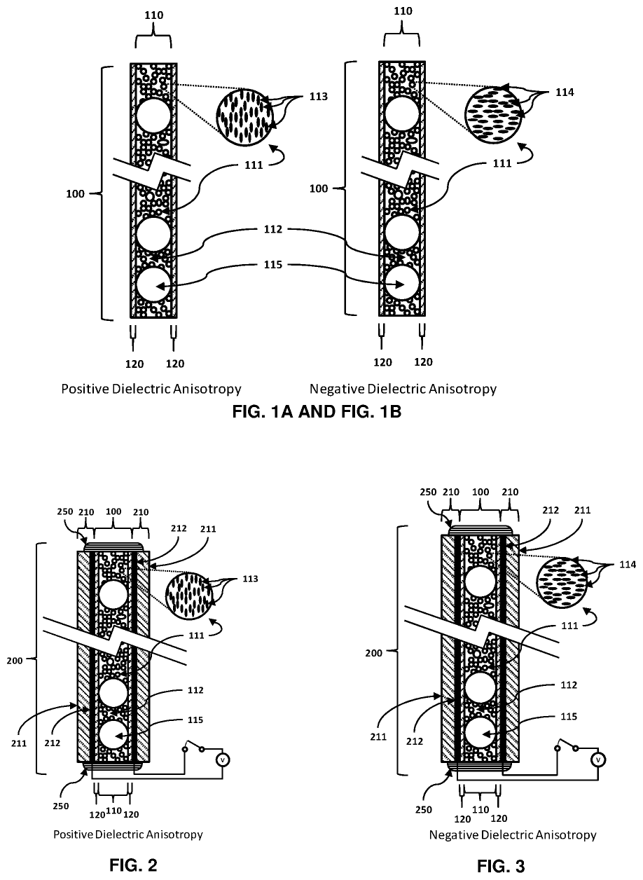

Some embodiments of the disclosure may be generally represented by FIG. 1A or FIG. 1B. FIG. 1A and FIG. 1B show two possible embodiments, each comprising a liquid crystal element, 100, one with positive dielectric anisotropy and the other with negative dielectric anisotropy. The liquid crystal element, e.g. liquid crystal element 100 can comprise a transparency changing layer, 110, and at least two alignment layers, 120, the alignment layers bounding each side of the transparency changing layer. The transparency changing layer has two opposing surfaces which can be adjacent to the first and second alignment layers respectively.

The transparency changing layer, 110, can comprise any of the aforementioned liquid crystal compositions, 111. In some embodiments, the transparency changing layer can further comprise a polymer dispersed liquid crystal (PDLC), 112. In some embodiments, as shown in FIG. 1, the composition is dispersed within the transparency changing layer such that the composition forms droplets, 111, suspended within the polymer matrix, 112. In some embodiments, the transparency changing layer can further comprise spacers, 115.

In some embodiments, the transparency changing layer can be described as a PDLC, where the liquid crystal mixture forms droplets within the polymer matrix. In some embodiments, the liquid crystal droplets form as suspended precipitate during the polymerization of the polymer precursors, and thus liquid crystalline mixture is suspended as a precipitate within the polymer. In some embodiments, the droplets can have a uniform distribution, a gradient distribution, or a random distribution within the polymer matrix. In some embodiments, the droplets can have a uniform distribution within the polymer matrix.

In some embodiments, the liquid crystal element can be opaque to visible light but turn transparent upon the application of an electric field, or a normal mode PDLC. In some embodiments, the liquid crystal element can be transparent to visual light but opaque upon the application of an electric field, or a reverse mode element. In some embodiments, the liquid crystal element can be characterized as a reverse mode PDLC element.

In some embodiments, the liquid crystal element can also comprise a surfactant. In some embodiments, the surfactant can comprise octanoic acid, heptanoic acid, hexanoic acid, and/or combinations thereof. In some embodiments, the surfactant can comprise acetylinic diol-based compounds, such as, for example, tetramethyl decynediol in a 2-ethyl hexanol solvent (Surfynol® 104A), ethoxylated acetylenic diols (Dynol® 604), dodecylbenzene sulfonate (Witconate® P-1059), Witcoamide® 511, Witcoamide® 5138, Surfynol® CT-171, Surfynol® CT-111, Surfynol® CT-131, Surfynol® TG, DBE Microemulsion, Fluorad® FC-431, Fluorad® FC-430, Surfynol® 104A, Dynol® 604, or combinations thereof.

### Selectively Dimmable Device

A selectively dimmable device can comprise the liquid crystal element, described herein, disposed between a first conductive substrate and a second conductive substrate. A selectively dimmable device also includes a voltage source which can be configured so that the substrates, the element, and the voltage source are all in electrical communication such that when a voltage is applied by the voltage source an electric field is applied across the element.

A conductive substrate can comprise a base, which comprises a conductive material, such as a conductive polymer. In some embodiments, the conductive polymer can comprise poly(3,4-ethylenediioxythiophene) (PEDOT), PEDOT: polystyrene sulfonate) (PSS), and/or combinations thereof.

In some embodiments, each conductive substrate can further comprise an electron conduction layer which is in physical communication with the base. In some embodiments, the electron conduction layer is placed in direct physical contact with the base, such as a layer on top of the base. In some embodiments, the electron conduction layer may be impregnated directly into the base (e.g., Indium Tin Oxide (ITO) glass) or sandwiched in between two bases to form a single conductive substrate. In some embodiments, where there is an electron conduction layer present, the base can comprise a non-conductive material. In some embodiments, non-conductive material can comprise glass, polycarbonate, polymer, or combinations thereof. In some embodiments, the substrate polymer can comprise polyvinyl alcohol (PVA), polycarbonate (PC), acrylics including but not limited to Poly(methacrylate) (PMMA), polystyrene, allyl diglycol carbonate (e.g. CR-39), polyesters, polyetherimide (PEI) (e.g. Ultem®), Cyclo Olefin polymers (e.g. Zeonex®), triacetylcellulose (TAC), polyethylene terephthalate (PET), polyethylene naphthalate (PEN), or combinations thereof. In some embodiments, the substrate can comprise polyethylene terephthalate (PET), polyethylene naphthalate (PEN), or a combination thereof. In some embodiments, the electron conduction layer can comprise a transparent conductive oxide, a conductive polymer, a metal grid, carbon nanotubes (CNT), graphene, or a combination thereof. In some embodiments, the transparent conductive oxide can comprise a metal oxide. In some embodiments, the metal oxide can comprise iridium tin oxide (IrTO), indium tin oxide (ITO), fluorine doped tin oxide (FTO), doped zinc oxide, or combinations thereof. In some embodiments, the metal oxide can comprise indium tin oxide incorporated onto the base, e.g. ITO glass, ITO PET, or ITO PEN.

Other optional components may also be included in a selectively dimmable device. These include, for example, a sealant, a removable backing, an adhesive layer, etc. These components may be included or omitted as desirable. Inclusion of these components in the description of specific devices is merely for illustration purposes, and should not be construed as limiting their use or inclusion only to those specific devices.

A liquid crystal composition or liquid crystal element can be incorporated into a selectively dimmable device. As shown in FIG. 2 and FIG. 3, in some embodiments, the selectively dimmable device, 200, can comprise: at least two conductive substrates, 210, the aforementioned liquid crystal element, e.g. liquid crystal element 100, and a voltage source. In some embodiments, the liquid crystal element can be disposed between the first conductive substrate and second conductive substrate. In some embodiments, the liquid crystal element, the conductive substrates, and the voltage source are in all in electrical communication such that upon the application of a voltage from the voltage source, an electric field is applied across the liquid crystal element.

In some embodiments, the conductive substrates can each comprise a base, e. g. base 211, where the base can be conductive. In some embodiments, each conductive substrate can further comprise an electron conductive layer, e.g. electron conductive layer 212, in addition to the base, the electron conduction layer is in physical communication with the base. In some embodiments with electron conduction layers, the base can be non-conductive.

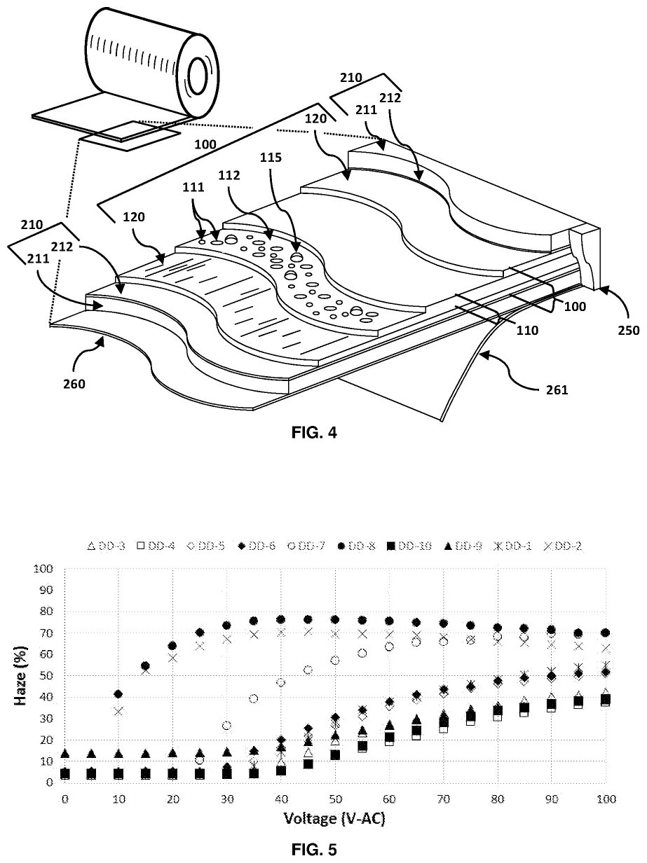

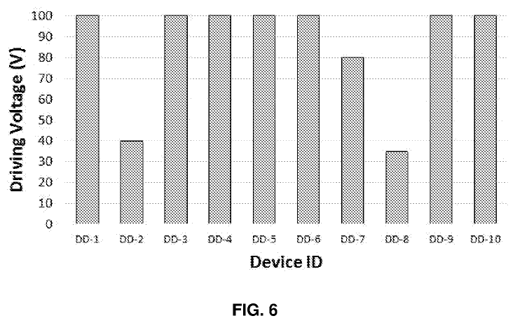

In some embodiments, the device can further comprise a sealant, e.g. sealant 250, to protect the liquid crystal element from the environment. In some embodiments, the device can further comprise an adhesive layer, e.g. adhesive layer 260, and a removable backing, e.g. removable backing 261 (FIG. 4), to allow application to existing windows.

As shown in FIG. 2 and FIG. 3, in some embodiments of the device the liquid crystal element integrated into the device, e.g. liquid crystal element 100, can comprise a polymer matrix, e.g. polymer matrix 112, in which the polymer dispersed liquid crystal droplets, 111, are suspended, all bound or bounded by two alignment layers, 120. In some embodiments of the device, as shown in FIG. 2, the liquid crystal droplets can comprise a positive dielectric anisotropic compound, 114. In other embodiments of the device, as shown in FIG. 3, the liquid crystal droplets can comprise a negative dielectric anisotropic compound, 113. In still other embodiments, the liquid crystal droplets can comprise a combination of positive and negative dielectric anisotropic compounds.

In some embodiments of the device, the liquid crystal element can be chosen such that under a condition when there is no induced electric field is present, within the transparency changing layer, the index of refraction of the liquid crystal composition and the index of refraction of the polymer are similar relative to each other so that the total transmission of visible light allowed to pass through the device can be at least about 70%, at least about 75%, at least about 80%, at least about 85%, at least about 90%, and/or at least about 95%. In some embodiments, when there is an electric field present, e.g. due to a voltage applied to the electrical circuit, the index of refraction of the liquid crystal and the index of refraction of the polymer can vary relative to each other so that incident light is scattered and at most only about 70%, only about 65%, only about 60%, only about 50%, only about 30%, only about 25%, only about 15%, only about 10%, only about 5% of visible light is allowed to pass through the device. In some embodiments, the magnitude of the electric field necessary achieve scattering corresponds to applying a voltage of less than 120 V, less than 110 V, less than 50 V, less than 40 V, less than 20 V, less than 15 V, less than 12 V, less than 10 V, less than 5V across the device. In some embodiments, the electric field across the device is less than about 500 kV/m, less than about 1,000 kV/m, less than about 5,000 kV/m, less than about 10,000 kV/m, less than about 20,000 kV/m, less than about 40,000 kV/m to less than about 80,000 kV/m. While not wanting to be limited by theory, the effectiveness of dimming of the device can also be depicted in terms of percentage of haze, which generally can be defined as:

$$Haze [ \% ] = \frac{Total Light Transmitted - Diffuse Light Transmitted}{Total Light Transmitted} \times 100 \% ,$$

where the total light transmitted is the light from a known source and the diffuse light transmitted is the light transmitted through the element. In some embodiments, the haze of the device can be a maximum of about 5%, about 10%, about 15%, about 20%, about 25%, about 30% when no voltage is applied to the device. In some embodiments, the haze of the device can be at least about 30%, about 35%, about 40%, about 50%, about 70%, about 75%, about 85%, about 90%, about 95%, when a voltage of at about 15 volts, about 30 volts, about 40 volts, about 60 volts, or more, applied to achieve scattering.

In some embodiments, the device can be semi-rigid or rigid. In some embodiments, the device can be flexible. A device is flexible if it can have a radius of curvature of 5 to 100 mm without withstanding material failure (e.g., fractures and delamination). In some embodiments, a selectively dimmable device can form a flexible sheet, as shown in FIG. 4, which can be applied between or on the surface of preexisting windows. In some embodiments, the conductive substrates can comprise flexible materials so that the aforementioned device may be a flexible film. In some embodiments, the flexible device may be placed in between or one side of pre-existing window glass to provide a dimming capability. In other embodiments, the device can be rigid, the base comprising inflexible materials.

In some embodiments, as shown in FIG. 2 and FIG. 3, the selectively dimmable device can also comprise a sealant, such as sealant 250. In some embodiments, the sealant can encapsulate liquid crystal element between the conductive substrates to protect the element from the environment. In some embodiments, the sealant can comprise a two-part real time cure epoxy, 3-Bond 2087, or the like. In some embodiments, the sealant can comprise a UV-curable photopolymer, such as NOA-61, or the like. In some embodiments, as shown in FIG. 4, the selectively dimmable device can also comprise an adhesive layer, e.g. adhesive layer 260. In some embodiments, the adhesive layer will allow a flexible sheet embodiment of the aforementioned device to be installed on pre-existing windows. In some embodiments, the adhesive can comprise an optically clear adhesive (OCA). In some embodiments, the OCA can comprise OCA products commercially available and known to those skilled in the art (e.g. Nitto OCA tape, Scapa OCA tape). In some embodiments, the selectively dimmable device can also comprise a removable carrier substrate, or backing, such as backing 261, to protect the adhesive layer from contamination which will be peeled away before the device's application.

### EXAMPLES

It has been discovered that embodiments of the liquid crystal composition and related reverse-mode polymer dispersed liquid crystal elements and devices described herein provide the ability for a selectively dimmable surface. These benefits are further shown by the following examples, which are intended to be illustrative of the embodiments of the disclosure, but are not intended to limit the scope or underlying principles in any way.

In general, the preparation of the compounds was performed in an argon atmosphere (Airgas, San Marcos, Calif. USA) or a nitrogen atmosphere (Airgas) inside of a fume-hood. In addition, where degassing is mentioned it can be performed by bubbling of argon (Airgas) through the compound or other similar methods.

### Example 1.1

### Synthesis of Liquid Crystal, 1-(5-pentylthiazol-2-yl)-N-(3,3′,4′-trifluoro-[1,1′-biphenyl]-4-yl)methanimine # LC-1

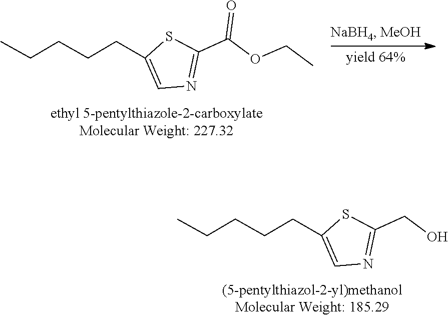

(5-Pentylthiazol-2-yl)methanol: Sodium borohydride (1.135 g, 30 mmol) was added in small portion to a solution mixture of ethyl 5-pentylthiazole-2-carboxylate (2.27 g, 10 mmol) in anhydrous MeOH (80.0 mL) at RT, the resulting mixture was stirred at RT for 3 hours. Solvent was removed under reduced pressure, the residue was dissolved into ethyl acetate and washed with water. Purification by silica gel column chromatography with hexane:ethyl acetate (9:1) gained 1.1 g light yellow liquid of (5-pentylthiazol-2-yl)methanol. Yield=64%.

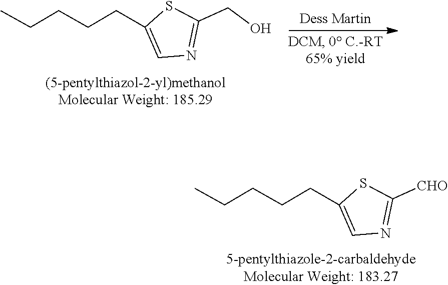

5-Pentylthiazole-2-carbaldehyde: To a mixture of (5-pentylthiazol-2-yl)methanol (0.77 g, 4.15 mmol) in DCM (30.0 mL) was added Dess-Martin periodinane (1.94 g, 4.56 mmol) at room temperature. The resulting mixture was stirred at RT for 16 hours the diluted with DCM (100 mL) washed with water, brine, separate dried over MgSO₄. Purification by silica gel column chromatography with Hexane:ethyl acetate (1:1) gained 0.5 g light yellow liquid of 5-pentylthiazole-2-carbaldehyde. Yield=65%.

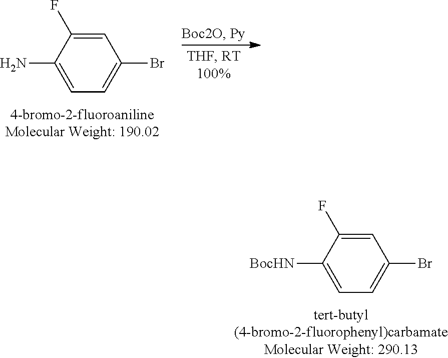 [SMILES: Nc1ccc(Br)cc1F ; CC(C)(C)OC(=O)Nc1ccc(Br)cc1F]

Tert-butyl(4-bromo-2-fluorophenyl)carbamate: To a mixture of 4-bromo-2-fluoroaniline (9.501 g, 50.0 mmol), Pyridine (16 mL, 198 mmol) in THF (100.0 mL) was added BOC anhydride (13.09 g, 60.0 mmol) in small portions at room temperature. The resulting mixture was stirred at RT for 16 hours under nitrogen atmosphere. The white precipitate was filtered off. The filtrate diluted with ethyl acetate (300 mL) washed with water, brine, separate dried over MgSO₄. Concentrated to dryness to gain 14.5 g colorless of tert-butyl(4-bromo-2-fluorophenyl) carbamate. The product was used into next step without further purification. Yield=95%.

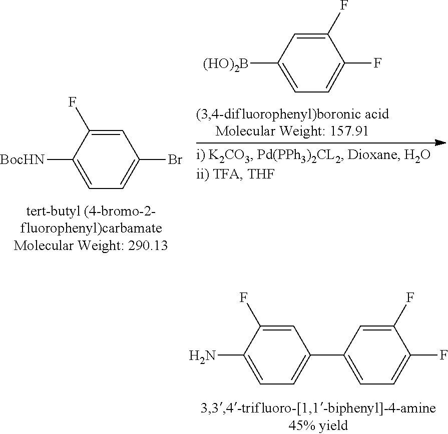 [SMILES: OB(O)c1ccc(F)c(F)c1 ; CC(C)(C)OC(=O)Nc1ccc(Br)cc1F ; Nc1ccc(-c2ccc(F)c(F)c2)cc1F]

3,3′,4-Trifluoro-[1,1′-biphenyl]-4-amine: A mixture of (3,4-difluorophenyl)boronic acid (7.895 g, 50.0 mmol, tert-butyl(4-bromo-2-fluorophenyl)carbamate (14.506 g, 50.0 mmol), Pd(PPh₃)₂Cl₂ (1.754, 2.5 mmol) and toluene (250 mL) was stirred and bubbled with argon for 15 minutes at RT. A mixture of K₂CO₃ (13.821 g, 100.0 mmol) in H₂O (50 mL) was added to above mixture. The resulting mixture was bubbled with argon for 15 minutes then stirred at 95° C. for 3 hours. After cooling to RT, the mixture was passed through celite then diluted with ethyl acetate. Organic layer was washed with H₂O. The organic layer was separated, dried over anhydrous magnesium sulfate, filtered and concentrated to dryness under reduced pressure. The residue was dissolved into 100 mL of DCM, 100 mL of TFA was added at 0° C. The resulting mixture was stirred at 68° C. for 3 hours. Solvent and TFA were removed under reduced pressure. The residue was purified by silica gel column chromatography with hexane:ethyl acetate (95:5) to gain 5.02 g a light brown solid of 3,3′,4′-trifluoro-[1,1′-biphenyl]-4-amine, Yield=45%.

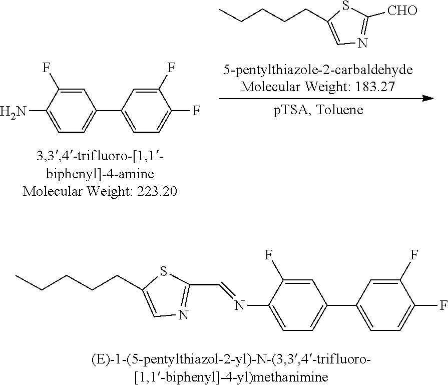 [SMILES: CCCCCc1cnc(C=O)s1 ; Nc1ccc(-c2ccc(F)c(F)c2)cc1F ; CCCCCc1cnc(/C=N/c2ccc(-c3ccc(F)c(F)c3)cc2F)s1]

1-(5-Pentylthiazol-2-yl)-N-(3,3′,4′-trifluoro-[1,1′-biphenyl]-4-yl)methanimine (LC-1): A mixture of 5-pentylthiazole-2-carbaldehyde (0.458 g, 2.5 mmol) and 3,3′,4′-trifluoro-[1,1′-biphenyl]-4-amine (0.585 g, 2.62 mmol) and p-toluenesulfonic acid (catalytic amount) in anhydrous toluene (25.0 mL) was placed in a round bottle flask equipped with Dean Stark trap and condenser. The mixture was heated to reflux under nitrogen atmosphere for 16 hours. The mixture was concentrated to dryness. Column chromatography by pretreated silica gel column with triethylamine and eluting with hexane:ethyl acetate:Et₃N then re-crystallization from MeOH gained 150 mg light yellow solid of 1-(5-pentylthiazol-2-yl)-N-(3,3′,4′-trifluoro-[1,1′-biphenyl]-4-yl)methanimine Yield=15%. ¹H NMR (400 MHz, CDCl₃) δ 8.75 (s, 1H), 7.72 (s, 1H), 7.44-7.25 (m, 6H), 2.92 (t, J=7.4 Hz, 2H), 1.78-1.74 (m, 2H), 1.5-1.36 (m, 4H), 0.91 (t, J=6.34 Hz, 3H).

### Example 1.2

### Synthesis of Liquid Crystal, N-(5-pentylthiazol-2-yl)-1-(3,3′,4′-trifluoro-[1,1′-biphenyl]-4-yl)methanimine # LC-2

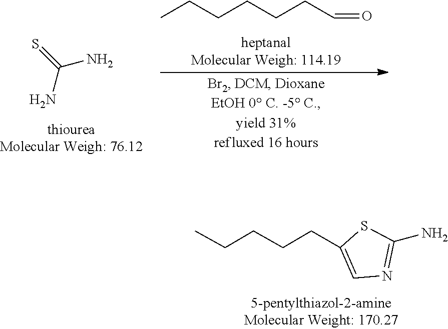

5-Pentylthiazol-2-amine: 202 mL of 2% v/v of bromine in anhydrous 1,4-dioxane was added dropwise to a solution of heptanal (12.997 mL, 93 mmol) in anhydrous 1,4-dioxane (75 mL) at 0° C. under an atmosphere of nitrogen. The reaction mixture was stirred at 0-5° C. for 2 hours. Thiourea (14.15 g, 186 mmol) was added following by EtOH (25 mL) to above mixture at 0° C., the resulting mixture was stirred at reflux for 3 hours. After cooling to RT, the mixture was concentrated to dryness, the residue was diluted with DCM and the product was extracted into 1M HCl aq.soln. The aqueous layer was basified with 30% ammonium hydrate with NaHCO₃ and the product was extracted into DCM. Organic layer was separated, dried over anhydrous magnesium sulfate, filtered and concentrated to dryness under reduced pressure. Purification by silica gel column chromatography with hexane:ethyl acetate (1:1) gained 5 g a light brown solid of 5-pentylthiazol-2-amine, Yield=31%.

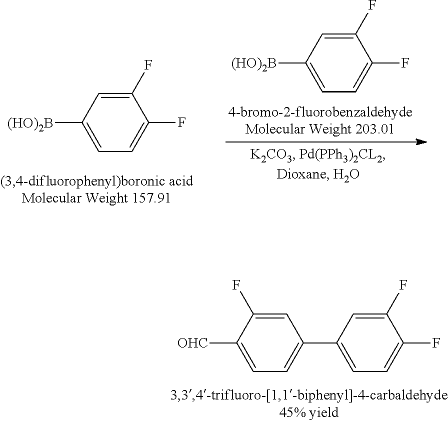 [SMILES: OB(O)c1ccc(F)c(F)c1 ; OB(O)c1ccc(F)c(F)c1 ; O=Cc1ccc(-c2ccc(F)c(F)c2)cc1F]

3,3′,4′-Trifluoro-[1,1′-biphenyl]-4-carbaldehyde: A mixture of (3,4-difluorophenyl)boronic acid (3.947 g, 25.0 mmol, 4-bromo-2-fluorobenzaldehyde (4.466 g, 22.0 mmol), Pd(PPh₃)₂Cl₂ (0.617 g, 0.88 mmol) and dioxane (50 mL) was stirred and bubbled with argon for 15 minutes at RT. A mixture of K₂CO₃ (6.91 g, 50.0 mmol) in H₂O (5 mL) was added to above mixture. The resulting mixture was bubbled with argon for 15 minutes then stirred at 75° C. for 3 hours. After cooling to RT, the mixture was diluted with ethyl acetate, washed with water. The organic layer was separated, dried over anhydrous magnesium sulfate, filtered and concentrated to dryness under reduced pressure. Purification by silica gel column chromatography with hexane:ethyl acetate (95:5) to gain 3.38 g a colorless solid of 3,3′,4′-trifluoro-[1,1′-biphenyl]-4-carbaldehyde. Yield 65%.

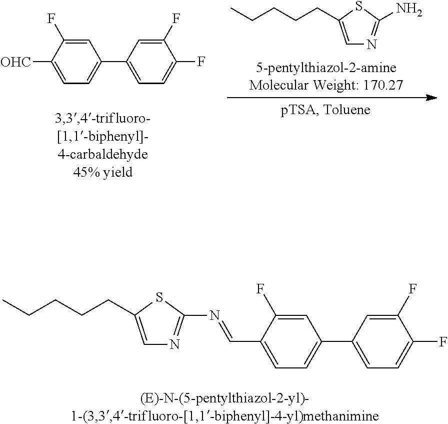 [SMILES: O=Cc1ccc(-c2ccc(F)c(F)c2)cc1F ; CCCCCc1cnc(N)s1 ; CCCCCc1cnc(/N=C/c2ccc(-c3ccc(F)c(F)c3)cc2F)s1]

N-(5-Pentylthiazol-2-yl)-1-(3,3′,4′-trifluoro-[1,1′-biphenyl]-4-yl)methanimine (LC-2): A mixture of 3,3′,4′-trifluoro-[1,1′-biphenyl]-4-carbaldehyde (1.85 g, 7.8 mmol) and 5-pentylthiazol-2-amine (1.33 g, 7.8 mmol) and p-toluensulfonic acid (catalytic amount) in anhydrous toluene (35.0 mL) was placed in a round bottle flask equipped with Dean Stark trap and condenser. The mixture was heated to reflux under nitrogen atmosphere for 16 hours. The mixture was concentrated to dryness. Re-crystallization from hexane and MeOH gained 150 mg dark yellow solid of (E)-N-(5-pentylthiazol-2-yl)-1-(3,3′,4′-trifluoro-[1,1′-biphenyl]-4-yl)methanimine. Yield=10%. ¹H NMR (400 MHz) (CDCl₃) δ 9.26 (s, 1H), 8.32 (t, J=7.82, 1H), 7.48-7.32 (m, 6H), 2.84 (t, J=7.84, 2H), 1.76-1.68 (m, 2H), 1.5-1.36 (m, 6H), 0.91 (t, J=6.43 Hz, 3H).

### Example 1.3

### Synthesis of Liquid Crystal, 3,3′,4′-trifluoro-[1,1′-biphenyl]-4-yl 5-pentylthiazole-2-carboxylate # LC-3

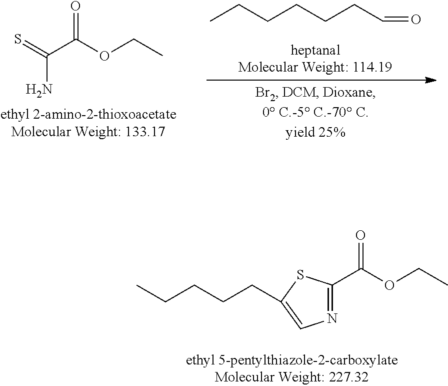

Ethyl 5-pentylthiazole-2-carboxylate: A mixture of bromine (8.1 mL, 158 mmol) in anhydrous methylene chloride (60.0 mL) and dioxane (15 mL) was added dropwise to a solution of heptanal (44.13 mL, 158 mmol) in anhydrous methylene chloride (80.0 mL) at 0° C. under an atmosphere of nitrogen. The reaction mixture was stirred at 0-5° C. for 2 hours. Ethyl 2-amino-2-thioxoacetate (21.02 g, 158 mmol) was added in small portion to above mixture at 0° C., the resulting mixture was stirred at 78° C. for 3 hours. After cooling to RT, the mixture was diluted with ethyl acetate, washed with NaHCO₃ saturated aqueous solution then H₂O. Organic layer was separated, dried over anhydrous magnesium sulfate, filtered and concentrated to dryness under reduced pressure. Purification by silica gel column chromatography with hexane:ethyl acetate (7:3) gained 8.9 g of a light brown solid of ethyl 5-pentylthiazole-2-carboxylate, Yield=25%.

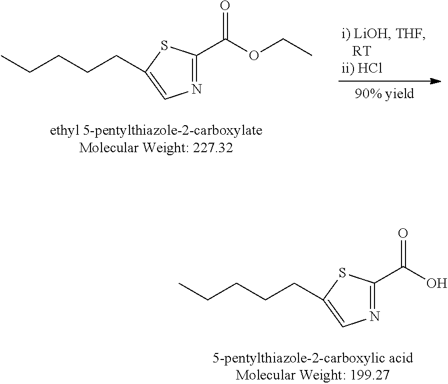

5-Pentylthiazole-2-carboxylic acid: A mixture of ethyl 5-pentylthiazole-2-carboxylate (2.273 g, 10.0 mmol) and LiOH (1.08 g, 45.0 mmol) in THF (15.0 mL) and H₂O (25 mL) was stirred at room temperature for 2 hours. It was then successively diluted with ethyl acetate (25 mL) the mixture was acidified with 6 N aqueous solution of hydrogen chloride. The organic layer was separated, dried over anhydrous magnesium sulfate, filtered and concentrated to dryness under reduced pressure. The solid 5-pentylthiazole-2-carboxylic acid product was washed with Hexane to gain 1.79 g off white solid. Yield was 90%. The product was used below without further purification.

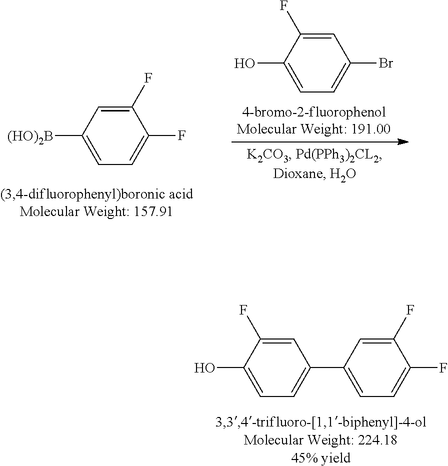 [SMILES: OB(O)c1ccc(F)c(F)c1 ; Oc1ccc(Br)cc1F ; Oc1ccc(-c2ccc(F)c(F)c2)cc1F]

3,3′,4′-Trifluoro-[1,1′-biphenyl]-4-ol: A mixture of (3,4-difluorophenyl)boronic acid (3.82 g, 20.0 mmol, 4-bromo-2-fluorophenol (3.158 g, 20.0 mmol), Pd(PPh₃)₂Cl₂ (0.561 g, 0.8 mmol) and dioxane (40 mL) was stirred and bubbled with argon for 15 minutes at RT. A mixture of K₂CO₃ (5.528 g, 40.0 mmol) in H₂O (5 mL) was added to above mixture. The resulting mixture was bubbled with argon for 15 minutes then stirred at 75° C. for 3 hours. After cooling to RT, the mixture was acidified with 6 N aqueous solution of hydrogen chloride then diluted with ethyl acetate. Organic layer was separated, washed with H₂O. The organic layer was separated, dried over anhydrous magnesium sulfate, filtered and concentrated to dryness under reduced pressure. Purification by silica gel column chromatography with hexane:ethyl acetate (95:5) to gain 2.02 g a colorless solid of 3,3′,4′-trifluoro-[1,1′-biphenyl]-4-ol, Yield=45%.

3,3′,4′-Trifluoro-[1,1′-biphenyl]-4-yl-5-pentylthiazole-2-carboxylate (LC-3): N,N′-Dicyclohexylcarbodiimide (247.2 mg, 1.2 mmol) was added in small portion to a mixture of 5-pentylthiazole-2-carboxylic acid (199.2 mg, 1.0 mmol) and DMAP (0.2 mg, 0.016 mmol) in DMF anhydrous (8.0 mL) at 0° C. under nitrogen atmosphere. The resulting mixture was stirred at 0° C. for 15 minutes. 3,3′,4′-Trifluoro-[1,1′-biphenyl]-4-ol (448.3 mg, 2 mmol) in DMF (2 mL) was added to above mixture via syringe at 0° C. The resulting mixture was stirred at room temperature for 5 hours under nitrogen atmosphere. The white precipitate was filtered off and the filtrate was diluted with ethyl acetate (25 mL), washed with H₂O, dried over anhydrous magnesium sulfate, filtered and concentrated to dryness under reduced pressure. Purification by silica gel column chromatography with Hexane:DCM (7:3) to (1:4) gained 119 mg colorless solid of 3,3′,4′-trifluoro-[1,1′-biphenyl]-4-yl-5-pentylthiazole-2-carboxylate. Yield=25%. ¹H NMR (400 MHz) (CDCl₃) δ ppm 7.85 (s, 1H), 7.41-7.25 (m, 6H), 2.97 (t, J=7.58 Hz, 2H), 1.79-1.76 (m, 2H), 1.58-1.39 (m, 4H), 0.91 (t, J=6.43 Hz, 3H).

### Example 1.4

### Synthesis of Liquid Crystal, (E)-1-(2-pentylthiazol-5-yl)-N-(3,3′,4′-trifluoro-[1,1′-biphenyl]-4-yl)methanimine # LC-4

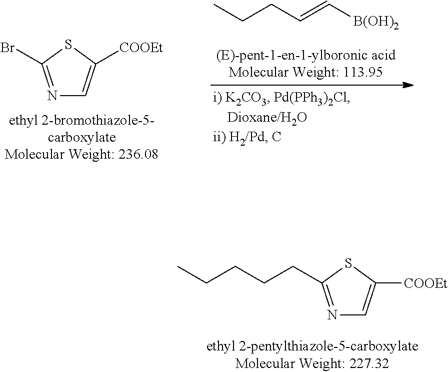

Ethyl 2-pentylthiazole-5-carboxylate: Under nitrogen protection, a mixture of ethyl 2-bromothiazole-5-carboxylate (9.44 g, 40.00 mmol) (Combi Block), Pd(PPh₃)₂Cl₂ (0.561 g, 0.8 mmol), K₂CO₃ (11.056 g, 80.00 mmol), (E)-pent-1-en-1-ylboronic acid (10.197 g, 52.0 mmol), dioxane (200 mL), and H₂O (50 mL) was stirred at 90° C. for 16 hours. The mixture was cooled to RT than poured into water. The organic layer was extracted into ethyl acetate (350 mL) and washed twice with water (2×150 mL). The organic layer was separated, concentrated to dryness. The crude product was purified by silica gel column chromatography; hexanes/ethyl acetate (9:1) were used for eluting to gain 5.96 g light yellow liquid product. Yield 65.5%. Next, A mixture of the above product and 10% Pd/C (w/w) (0.25 g) in 50 mL of methanol:ethyl acetate (1:1) was hydrogenated with Parr shaker under H₂ atmosphere (60 psi) for 16 hours. The catalyst was removed by filtration and the filtrate was concentrated to dryness to gain 5.8 g light yellow liquid product which was used next step without further purification. Yield 99%. LCMS M+H=228

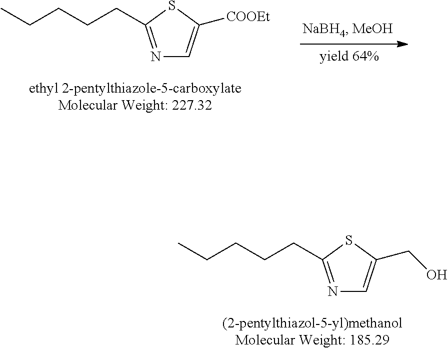

(2-Pentylthiazol-5-yl)methanol: Sodium borohydride (12.495 g, 65.97 mmol) was added in small portion to a solution mixture of ethyl 2-pentylthiazole-5-carboxylate (5.0 g, 21.99 mmol) in anhydrous methanol (100.0 mL) at RT, the resulting mixture was stirred at RT for 16 hours. The mixture was poured into ice water; the pH was adjusted to 5-6 with 3N HCl aqueous solution. Ethyl acetate (450 mL) was added. Organic layer was separated then washed with water, brine; dried over MgSO₄. The solvent was removed under reduced pressure; the residue was washed with hexanes. The product was collected by filtering and dried in vacuo oven to gain 3.87 g colorless solid of (2-pentylthiazol-5-yl)methanol. Yield 95%. LCMS M+H=186.

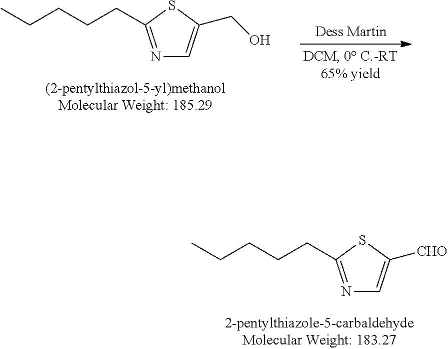

2-Pentylthiazole-5-carbaldehyde: To a mixture of (2-pentylthiazol-5-yl) methanol (2.6 g, 14.03 mmol) in DCM (100.0 mL) was added Dess-Martin periodinane (7.185 g, 16.83 mmol) at room temperature. The resulting mixture was stirred at RT for 16 hours the diluted with DCM (100 mL) washed with water, brine, separated, and dried over MgSO₄. Purification by silica gel column chromatography with hexane:ethyl acetate (1:1) gained 1.67 g light yellow liquid of 2-pentylthiazole-5-carbaldehyde. Yield=65%. LCMS M+H=184.

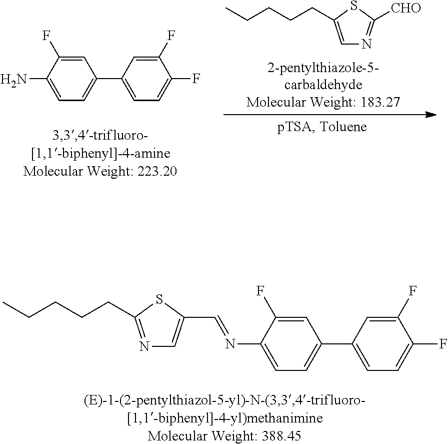 [SMILES: Nc1ccc(-c2ccc(F)c(F)c2)cc1F ; CCCCCc1cnc(C=O)s1 ; CCCCCc1ncc(/C=N/c2ccc(-c3ccc(F)c(F)c3)cc2F)s1]

(E)-1-(2-Pentylthiazol-5-yl)-N-(3,3′,4′-trifluoro-[1,1′-biphenyl]-4-yl)methanimine (LC-4): A mixture of 2-pentylthiazole-5-carbaldehyde (0.458 g, 2.5 mmol) and 3,3′,4′-trifluoro-[1,1′-biphenyl]-4-amine (0.585 g, 2.62 mmol) and p-toluenesulfonic acid (catalytic amount) in anhydrous toluene (25.0 mL) was placed in a round bottle flask equipped with Dean Stark trap and condenser. The mixture was heated to reflux under nitrogen atmosphere for 16 hours. The mixture was concentrated to dryness. Column chromatography by aluminum oxide column and eluting with hexane/ethyl acetate (9:1) then re-crystallization from methanol, gained 150 mg light yellow solid of (E)-1-(2-pentylthiazol-5-yl)-N-(3,3′,4′-trifluoro-[1,1′-biphenyl]-4-yl)methanimine. Yield=15%. LCMS M+H=389.

### Example 1.5

### Synthesis of Liquid Crystal, 3,3′,4′-trifluoro-[1,1′-biphenyl]-4-yl 2-heptylthiazole-5-carboxylate # LC-5

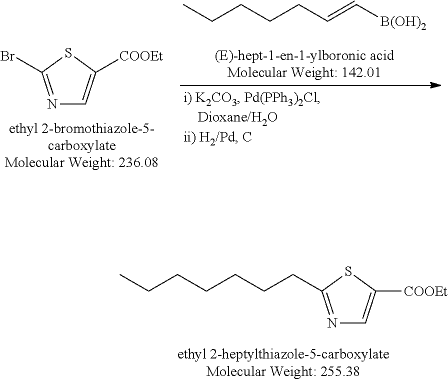

Ethyl 2-heptylthiazole-5-carboxylate: Under nitrogen protection, a mixture of ethyl 2-bromothiazole-5-carboxylate (3.446 g, 14.6 mmol), Pd(PPh₃)₂Cl₂ (205 mg, 0.229 mmol), K₂CO₃ (4.035 g, 29.2 mmol), (E)-hept-1-en-1-ylboronic acid (2.5 g, 17.6 mmol), dioxane (30 mL), and H₂O (5 mL) was stirred at 95° C. for 16 hours. The mixture was cooled to RT than poured into water. The organic layer was extracted into ethyl acetate (150 mL) and washed twice with water (2×35 mL). The organic layer was separated, concentrated to dryness. The crude product was purified by silica gel column chromatography; hexanes/ethyl acetate were used for eluting to gain 2.19 g yellow liquid product. Yield 59%.

A mixture of the above product and 10% Pd/C (w/w) (0.25 g) in 50 mL of methanol:ethyl acetate (1:1) was hydrogenated with Parr shaker under H₂ atmosphere (60 psi) for 16 hours. The catalyst was removed by filtration and crude product was purified by silica gel column chromatography; hexanes/ethyl acetate were used for eluting to gain 2.2 g off white liquid product. Yield 100%. LCMS M+H=256.

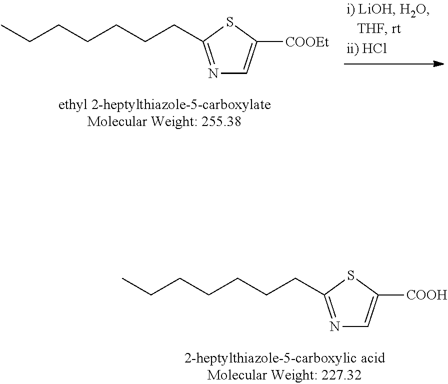 [SMILES: CCCCCCCc1ncc(C(=O)OCC)s1 ; CCCCCCCc1ncc(C(=O)O)s1]

2-Heptylthiazole-5-carboxylic acid: A mixture of ethyl 2-heptylthiazole-5-carboxylate (2.00 g, 7.83 mmol) in 10 mL of THF was treated with a solution mixture of LiOH (0.939 g, 39.15 mmol) in H₂O (5 mL) at room temperature. The resulting mixture was stirred at room temperature for 16 hours. 3N HCl aqueous solution was added to acidify at 0° C. The product was extracted into ethyl acetate. Organic layer was separated, dried MgSO₄ by filtration and concentrated. The crude product was recrystallized from hexanes to gain 1.7 g colorless solid product. Yield 95.5%. LCMS M−H=226.

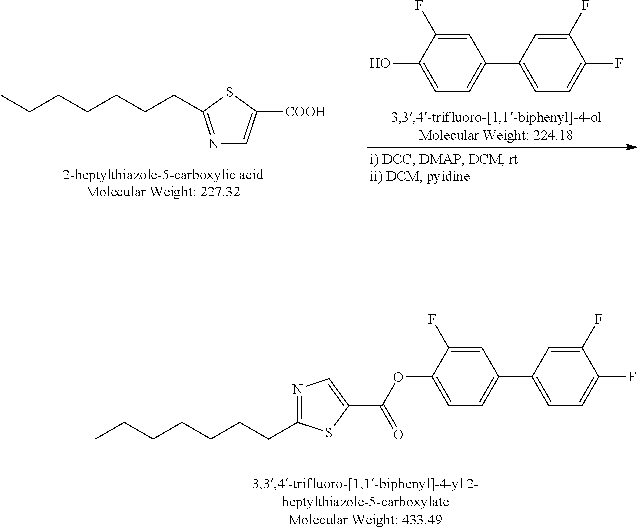 [SMILES: Oc1ccc(-c2ccc(F)c(F)c2)cc1F ; CCCCCCCc1ncc(C(=O)O)s1 ; CCCCCCCc1ncc(C(=O)Oc2ccc(-c3ccc(F)c(F)c3)cc2F)s1]

3,3′,4′-Trifluoro-[1,1′-biphenyl]-4-yl 2-heptylthiazole-5-carboxylate (LC-5): 3,3′,4′-trifluoro-[1,1′-biphenyl]-4-ol (0.287 g, 1.28 mmol), 1.28 mL of 1M solution of 1,3-dicyclohexylcarbodiimide in dichloromethane (264.1 mg, 1.28 mmol) and 4-dimethylaminopyridine (1.563 g, 12.8 mmol) were added to a solution of 2-heptylthiazole-5-carboxylic acid (0.290 g, 1.28 mmol) in diethyl ether (1 mL) at about 0° C. The reaction mixture was stirred overnight while being allowed to warm to room temperature. The precipitate was collected by filtration and was washed with diethyl ether. The combined filtrates were washed successively with water, 5% aqueous acetic acid, water and brine, dried (MgSO₄), filtered and concentrated under vacuum. The residue was purified by flash column chromatography on silica gel using hexane/ethyl acetate (5:1) as the mobile phase to provide 3,3′,4′-trifluoro-[1,1′-biphenyl]-4-yl 2-heptylthiazole-5-carboxylate as colorless solid (520 mg, 1.19 mmol); yield 92%. LCMS M+H=434. ¹H NMR (400 MHz) (DMSO) δ 8.61 (s, 1H), 7.92-7.87 (m, 1H), 7.84 (dd, J=1.6 Hz, 12.72 Hz, 1H), 7.66-7.51 (m, 4H), 3.08 (t, J=7.48 Hz, 2H), 1.81-1.74 (m, 2H), 1.36-1.17 (m, 8H), 0.86 (t, J=6.68 Hz, 3H).

### Example 1.6

### Synthesis of Liquid Crystal, 3,3′,4′-trifluoro-N-(5-pentylthiazol-2-yl)-[1,1′-biphenyl]-4-carboxamide # LC-6

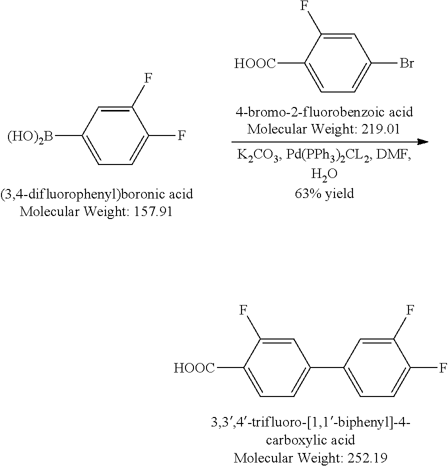 [SMILES: OB(O)c1ccc(F)c(F)c1 ; O=C(O)c1ccc(Br)cc1F ; O=C(O)c1ccc(-c2ccc(F)c(F)c2)cc1F]

3,3′,4′-Trifluoro-[1,1′-biphenyl]-4-carboxylic acid: A mixture of (3,4-difluorophenyl)boronic acid (7.64 g, 40.0 mmol, 4-bromo-2-fluorobenzoic acid (4.38 g, 20.0 mmol), Pd(PPh₃)₂Cl₂ (5.61 g, 0.8 mmol) and DMF (50 mL) was stirred and bubbled with Argon for 15 minutes at RT. A mixture of K₂CO₃ (5.52 g, 40.0 mmol) in H₂O (5.0 mL) was added to above mixture. The resulting mixture was bubbled with argon for 15 minutes then stirred at 100° C. for 3 hours. After cooling to RT, the mixture was poured to water, and acidified with 3N HCl aq. solution then diluted with ethyl acetate. The mixture was passed through celite. The organic layer was separated washed with water, dried over anhydrous magnesium sulfate, filtered and concentrated to dryness under reduced pressure. The residue was purified by silica gel column chromatography with hexane:ethyl acetate (9:1) to gain 3.17 g a grey color solid of 3,3′,4′-trifluoro-[1,1′-biphenyl]-4-carboxylic acid. Yield=63%.

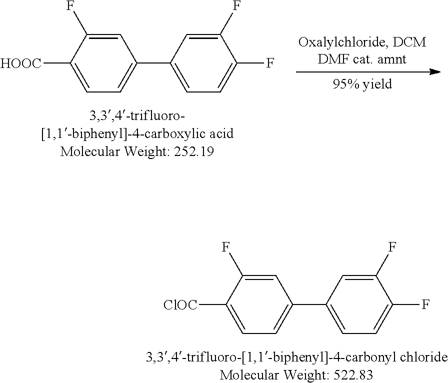

3,3′,4′-Trifluoro-[1,1′-biphenyl]-4-carbonyl chloride: To a mixture of 3,3′,4′-trifluoro-[1,1′-biphenyl]-4-carboxylic acid (2.52 g, 10.0 mmol), 3 drops of DMF in DCM (100.0 mL) and oxalyl chloride (1.13 mL, 1.3 mmol) was added dropwise at room temperature. The resulting mixture was stirred at RT for 3 hours until CO₂ releasing was ceased. The mixture was concentrated to dryness to gain 2.598 g grey solid of 3,3′,4′-trifluoro-[1,1′-biphenyl]-4-carbonyl chloride. Yield=96%.

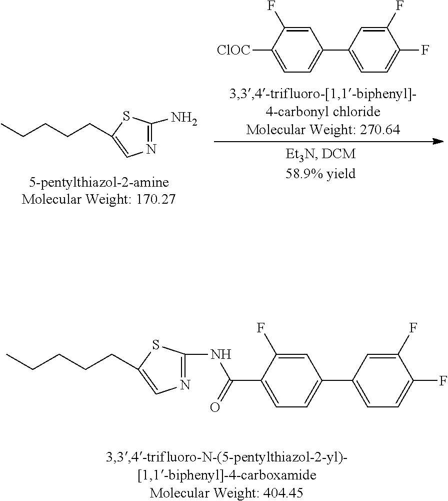

3,3′,4′-Trifluoro-N-(5-pentylthiazol-2-yl)-[1,1′-biphenyl]-4-carboxamide (LC-6): A mixture of 5-pentylthiazol-2-amine (0.25 g, 1.46 mmol) and triethylamine (296.5 mg, 2.93 mmol) in DCM anhydrous (3 mL) was added dropwise into a solution mixture of 3,3′,4′-trifluoro-[1,1′-biphenyl]-4-carbonyl chloride (0.595 g, 2.2 mmol) at 0° C. under nitrogen atmosphere. The mixture was allowed to RT for 3 hours. The mixture was poured to ice-water, extracted with ethyl acetate. The organic layer was separated washed with water, dried over anhydrous magnesium sulfate, filtered and concentrated to dryness under reduced pressure. The residue was dissolved into toluene (10 mL); the white solid product was precipitated and collected by filtration. The solid was dissolved into DCM and passed through a short silica gel column. After re-crystallization from methanol, 350 mg of a colorless needle shape crystal of 3,3′,4′-trifluoro-[1,1′-biphenyl]-4-carboxylic acid was gained. Yield=58.9%. ¹H NMR (400 MHz, CDCl₃) δ ppm 9.83 (s, 1H), 8.3 (t, J=8.2 Hz, 1H), 7.54-7.28 (m, 5H), 7.19 (s, 1H), 2.81 (t, J=7.49 Hz, 2H), 1.75-1.68 (m, 2H), 1.40-1.35 (m, 4H), 1.3-1.27 (m, 6H), 0.93 (t, J=7.02 Hz, 3H).

### Example 1.7

### Synthesis of Liquid Crystal, 3,3′,4′-trifluoro-N-(2-heptylthiazol-5-yl)-[1,1′-biphenyl]-4-carboxamide # LC-7

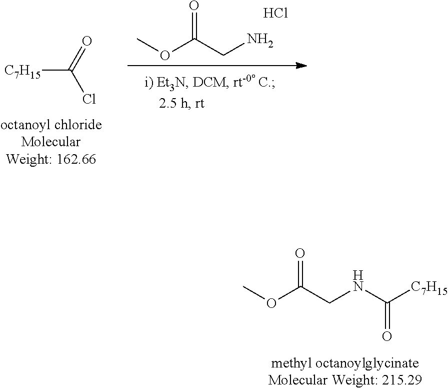

Methyl octanoylglycinate: A suspension of glycine hydrochloride (10.0 g, 79.64 mmol) in methylene chloride (400 mL), cooled to 0° C. under a nitrogen atmosphere, was treated with trimethylamine (44.4 mL, 318.6 mmol) and octanoyl chloride (14.95 mL, 87.6 mmol), and the mixture stirred at room temperature for 2.5 hours. The reaction was washed with saturated aqueous sodium bicarbonate (500 mL), water (500 mL) and brine. The organic phase was dried over anhydrous sodium sulfate, filtered and concentrated under vacuum giving the title compound. Purification by silica gel flash chromatography with 25% ethyl acetate/methylene chloride afforded the title compound as a colorless oil (10.506 g, 48.8 mmol); yield was 61%.

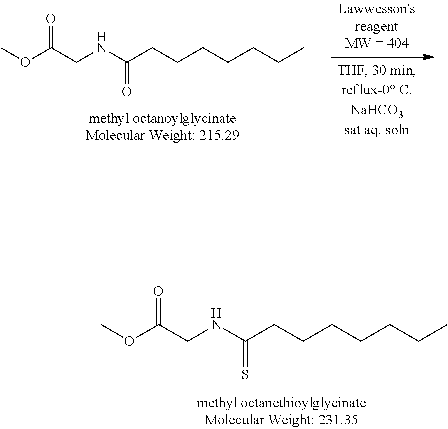

Methyl octanthioylglycinate: A solution of methyl octanoylglycinate (10.467 g, 48.62 mmol) in anhydrous THF (500 mL) was treated with Lawesson's reagent (13.38 g, 32.09 mmol), then heated at reflux under a nitrogen atmosphere for 30 minutes. The reaction was cooled to 0° C. and a saturated aqueous sodium bicarbonate solution (400 mL) was slowly added dropwise. The mixture was stirred at room temperature for 15 minutes, and then extracted with ethyl acetate (1000 mL), and the organic extract washed with saturated aqueous sodium bicarbonate (500 mL), water (2×250 mL), and brine. Dried the organic phase over anhydrous sodium sulfate, filtered, and concentrated under vacuum giving the title compound. Purification by silica gel flash chromatography with 1% ethyl acetate/methylene chloride afforded the title compound as a colorless oil (10.429 g, 45.08 mmol); yield was 93%.

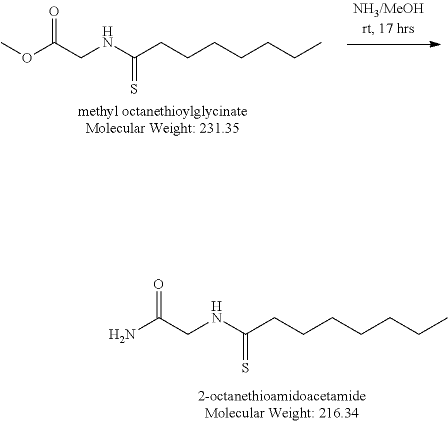

2-Octanethioamidoacetamide:methyl octanethioylglycinate (2.85 g, 12.32 mmol) was mixed with NH₃ 7N/MeOH (50 mL) and the reaction was stirred in a stoppered flask at room temperature for 17 hours. The solvent was concentrated under vacuum giving the title compound and the solid purified by silica gel flash chromatography with 50% ethyl acetate/hexanes to give the title compound as a white solid (2.00 g, 9.24 mmol); yield was 75%. LCMS M+H 217. ¹H NMR (400 MHz) (CDCl₃) δ ppm 8.01 (bs, 1H), 5.8 (bs, 1H), 5.6 (bs, 1H), 4.33 (d, J=4.4 Hz, 2H), 2.71 (t, J=7.72 Hz, 2H), 1.82-1.74 (m, 2H), 1.35-1.27 (m, 8H), 0.87 (t, J=6.84 Hz 3H).

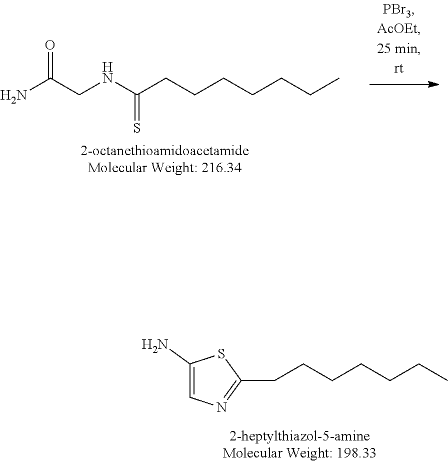

2-Heptylthiazol-5-amine: A solution of 2-octanethioamidoacetamide (5.332 g, 24.65 mmol) in anhydrous ethyl acetate (120 mL) was treated with phosphorous tribromide (1.89 mL, 19.72 mmol) under a nitrogen atmosphere and stirred at room temperature for 20 minutes. Added additional phosphorous tribromide (0.50 mL) and let stir for 5 minutes. The reaction mixture was diluted with ethyl acetate (500 mL) and washed with saturated aqueous sodium bicarbonate (25 mL). The aqueous wash was extracted with ethyl acetate (2×500 mL), and the organic extracts were combined and washed with brine, dried over anhydrous sodium sulfate, filtered and concentrated under vacuum giving the title compound. Purification by silica gel flash chromatography with 3% methanol/methylene chloride afforded the title product (2.243 g, 12.3 mmol); yield was 50%. LCMS M+H=190.

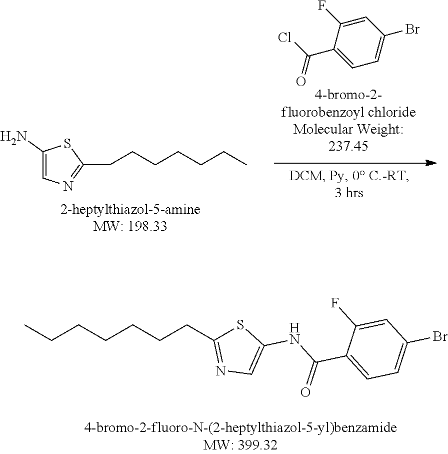 [SMILES: O=C(Cl)c1ccc(Br)cc1F ; CCCCCCCc1ncc(N)s1 ; CCCCCCCc1ncc(NC(=O)c2ccc(Br)cc2F)s1]

4-Bromo-2-fluoro-N-(2-heptylthiazol-5-yl)benzamide: Under protection of nitrogen atmosphere, a mixture of 4-bromo-2-fluorobenzoyl chloride (Combi block) (1.73 g, 7.31 mmol) in anhydrous DCM (10 mL) was added to a mixture of 2-heptylthiazol-5-amine (1.45 g, 7.31 mmol) and pyridine (2.35 mL, 29.24 mmol) in anhydrous DCM (25 mL) at 0° C. The mixture was stirred at room temperature for 3 hours, and then poured to ice and water, diluted with DCM (100 mL); the organic phase was washed with saturated NaHCO₃ aqueous solution then dried over anhydrous sodium sulfate, filtered, and concentrated under vacuum giving the title compound. Purification by silica gel flash chromatography with 10% ethyl acetate/methylene chloride afforded the title compound as a light brown solid (700 mg); yield 65%. LCMS M+H=420.

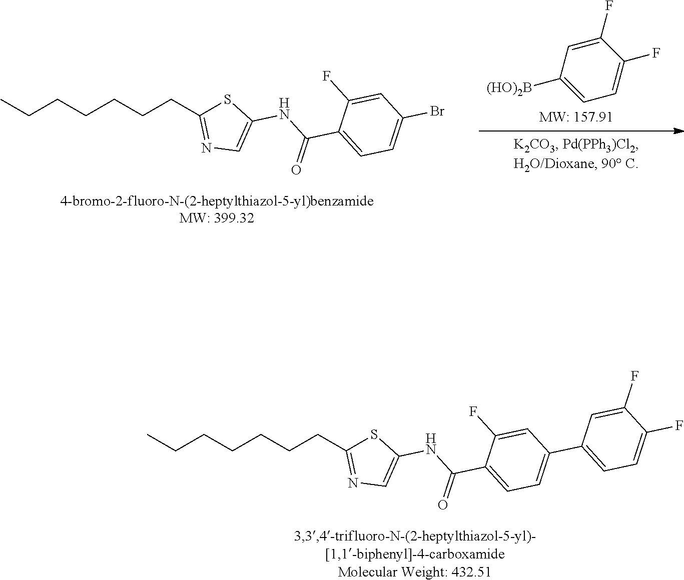 [SMILES: CCCCCCCc1ncc(NC(=O)c2ccc(Br)cc2F)s1 ; OB(O)c1ccc(F)c(F)c1 ; CCCCCCCc1ncc(NC(=O)c2ccc(-c3ccc(F)c(F)c3)cc2F)s1]

3,3′,4′-Trifluoro-N-(2-heptylthiazol-5-yl)-[1,1′-biphenyl]-4-carboxamide (LC-7): Under nitrogen protection, a mixture of 4-bromo-2-fluoro-N-(2-heptylthiazol-5-yl)benzamide (0.4 g, 1.00 mmol), Pd(PPh₃)₂Cl₂ (14 mg, 0.02 mmol), K₂CO₃ (276 mg, 2.00 mmol), 3,4-difluorophenylboronic acid (189.5 mg, 1.2 mmol), dioxane (25 mL), and H₂O (5 mL) was stirred at 90° C. for 16 hours. The mixture was cooled to RT than poured into water. The organic layer was extracted into ethyl acetate (150 mL) and washed twice with water (2×35 mL). The organic layer was separated, concentrated to dryness. The crude product was purified by silica gel column chromatography; DCM/ethyl acetate were used for eluting to gain 300 mg light brown solid product. Yield 74%. LCMS M+H=433. ¹H NMR (400 MHz) (DMSO) δ ppm 11.69 (s, 1H), 7.99-7.94 (m, 1H), 7.82-7.78 (m, 2H), 7.72 (dd, J=8.2 Hz, 1.52 Hz, 1H), 7.70-7.68 (m, 1H), 7.61-7.54 (m, 1H), 7.50 (s, 1H), 2.88 (t, J=7.4 Hz, 2H), 1.73-1.66 (m, 2H), 1.32-1.25 (m, 8H), 0.86 (t, J=6.86 Hz, 3H).

### Example 1.8

### Synthesis of Liquid Crystal, 5-pentyl-2-((3,3′,4′-trifluoro-[1,1′-biphenyl]-4-yl)oxy)thiazole) # LC-8

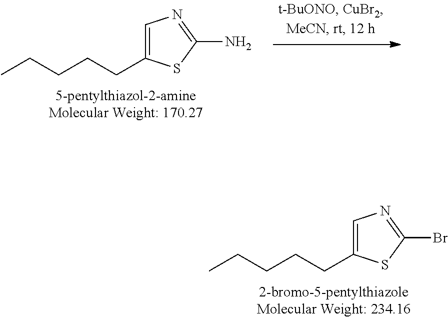

2-Bromo-5-pentylthiazole: To a suspension mixture of 5-pentylthiazol-2-amine (5 g, 29.36 mmol) in 60 mL of acetonitrile was added CuBr₂ (7.85 g, 35.21 mmol) followed by t-butyl nitrite (4.64 mL, 35.21 mmol) at 0° C. while stirring with magnetic bar. The mixture was concentrated in vacuo and ethyl acetate (200 mL) was added followed by 0.5M HCl aqueous solution (30 mL); the organic layer was separated, washed with brine, dried with MgSO₄, evaporated. The crude product was purified by silica gel column chromatography, eluting with hexanes:ethyl acetate (9:1) to gain 5.7 g light brown color solid product. Yield 82%.

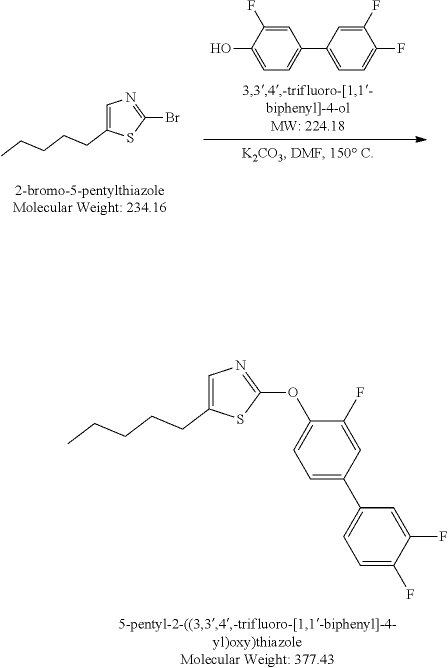 [SMILES: Oc1ccc(-c2ccc(F)c(F)c2)cc1F ; CCCCCc1cnc(Br)s1 ; CCCCCc1cnc(Oc2ccc(-c3ccc(F)c(F)c3)cc2F)s1]

5-Pentyl-2-((3,3′,4′-trifluoro-[1,1′-biphenyl]-4-yl)oxy)thiazole) (LC-8): Under nitrogen atmosphere, a mixture of 2-bromo-5-pentylthiazole (0.468 g, 2.0 mmol), 3,3′,4′-trifluoro-[1,1′-biphenyl]-4-ol (0.448 g, 2.0 mmol), K₂CO₃ (0.552 g, 4 mmol) in DMF anhydrous (20 mL) was stirred at 150° C. for 16 hours. After cooling to RT the mixture was poured into H₂O then extracted into ethyl acetate. The organic layer was separated, dried MgSO₄, and concentrated. The crude product was purified by silica gel column chromatography; Hexanes:ethyl acetate (95:5) was used for eluting. The product was re-crystallized from ethanol to gain 0.174 g off white solid desired product. Yield 10%. LCMS [M+1] 378. ¹H NMR (400 MHz) (CDCl₃) δ ppm 7.45 (t, J=8.12 Hz, 1H), 7.39-7.24 (m, 5H), 7.22 (s, 1H), 2.71 (t, J=7.57 Hz, 2H), 1.67-1.66 (m, 2H), 1.39-1.34 (m, 4H), 0.90 (t, J=6.4 Hz, 3H).

### Example 1.9

### Synthesis of Liquid Crystal, 1-(5-pentylthiazol-2-yl)-3-(3,3′,4′-trifluoro-[1,1′-biphenyl]-4-yl)urea # LC-9

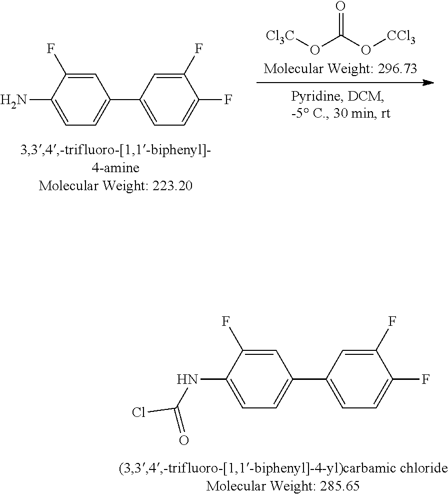

(3,3′,4′-Trifluoro-[1,1′-biphenyl]-4-yl)carbamic chloride: A solution of 3,3′,4′-trifluoro-[1,1′-biphenyl]-4-amine (0.937 g, 4.2 mmol) and dry pyridine (0.686 mL, 8.4 mmol) in anhydrous methylene chloride (10.0 mL) was added dropwise to a solution of triphosgene (5.04 g, 16.6 mmol) in anhydrous methylene chloride (10.0 mL) at −5° C. under an atmosphere of nitrogen. The reaction mixture was kept at −5° C. for 30 mins and was allowed to warm to room temperature over 30 mins. It was then successively diluted with methylene chloride (25 mL), quenched with a 1 N aqueous solution of hydrogen chloride (1.0 mL), diluted with water (10 mL) and decanted. The aqueous layer was extracted with methylene chloride (3×30 mL). The combined organic extracts were washed with a 1N aqueous solution of hydrogen chloride (20 mL), brine (20 mL), dried over anhydrous magnesium sulfate, filtered and concentrated to dryness under reduced pressure. The pink solid (3,3′,4′-trifluoro-[1,1′-biphenyl]-4-yl)carbamic chloride (0.5 g, Yield=83%) was used for the next step without purification and stored at −20° C. under an atmosphere of nitrogen.

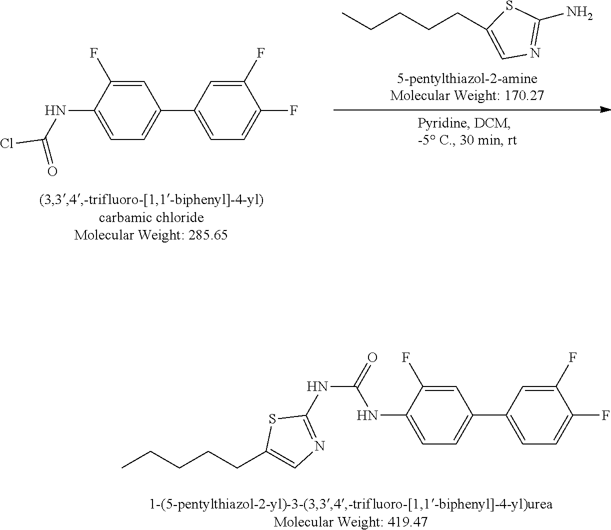 [SMILES: O=C(Cl)Nc1ccc(-c2ccc(F)c(F)c2)cc1F ; CCCCCc1cnc(N)s1 ; CCCCCc1cnc(NC(=O)Nc2ccc(-c3ccc(F)c(F)c3)cc2F)s1]

1-(5-Pentylthiazol-2-yl)-3-(3,3′,4′-trifluoro-[1,1′-biphenyl]-4-yl)urea (LC-9): A solution of 5-pentylthiazol-2-amine (170 mg, 1 mmol) and dry pyridine (0.163 mL, 2 mmol) in anhydrous methylene chloride (10.0 mL) was added dropwise to a solution of (3,3′,4′-trifluoro-[1,1′-biphenyl]-4-yl)carbamic chloride (342 mg, 1.2 mmol) in anhydrous methylene chloride (10.0 mL) at −5° C. under an atmosphere of nitrogen. The reaction mixture was kept at −5° C. for 30 mins and was allowed to warm to room temperature over 30 mins. It was then successively diluted with methylene chloride (25 mL), quenched with a 1 N aqueous solution of hydrogen chloride (1.0 mL), diluted with water (10 mL) and decanted. The aqueous layer was extracted with methylene chloride (3×30 mL). The combined organic extracts were washed with a 1 N aqueous solution of hydrogen chloride (20 mL), brine (20 mL), dried over anhydrous magnesium sulfate, filtered and concentrated to dryness under reduced pressure. The pink solid 1-(5-pentylthiazol-2-yl)-3-(3,3′,4′-trifluoro-[1,1′-biphenyl]-4-yl) urea was purified by silica gel column chromatography to gain 0.183 g colorless solid, yield 43%. LCMS [M+1] 420. ¹H NMR (400 MHz) (CDCl₃) δ ppm 10.64 (s, 1H), 9.07 (s, 1H), 8.22 (t, J=8.58 Hz, 1H), 7.86-7.80 (m, 1H), 7.71 (d, J=2.1 Hz, 1H), 7.68-7.17 (m, 3H) 7.09 (s, 1H), 2.6 (t, J=8.43 Hz, 2H), 1.62-1.55 (m, 2H), 1.34-1.25 (m, 4H), 0.87 (t, J=6.94 Hz, 3H).

### Example 1.10

### Synthesis of Liquid Crystal, 1-(2-butythiazolyl)-3-(3,3′,4′-trifluoro-[1,1′-biophenyl]4yl)urea # LC-10

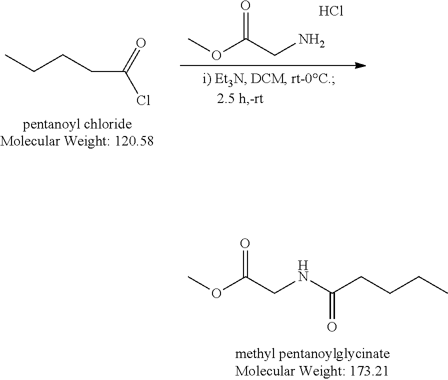

Methyl pentanoylglycinate: A suspension of glycine hydrochloride (10.0 g, 79.64 mmol) in methylene chloride (400 mL), cooled to 0° C. under a nitrogen atmosphere, was treated with triethylamine (44.4 mL, 318.6 mmol) and pentanoyl chloride (10.56 mL, 87.6 mmol), and the mixture stirred at room temperature for 2.5 hours. The reaction was washed with saturated aqueous sodium bicarbonate (500 mL), water (500 mL) and brine. The organic phase was dried over anhydrous sodium sulfate, filtered and concentrated under vacuum giving the title compound. Purification by silica gel flash chromatography with 25% ethyl acetate/methylene chloride afforded the title compound as a colorless oil (8.452 g, 48.8 mmol, 61%). LCMS M+H 174.

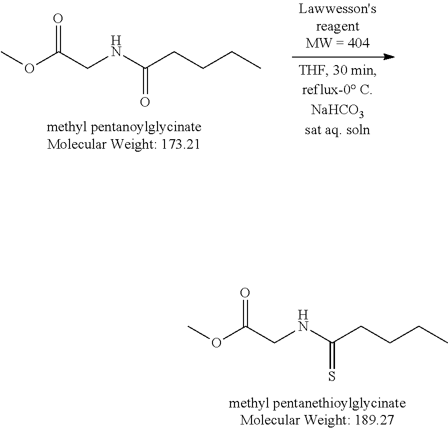

Methyl pentanethioylglycinate: A solution of methyl pentanoylglycinate (8.421 g, 48.62 mmol) in anhydrous THF (500 mL) was treated with Lawesson's reagent (13.38 g, 32.09 mmol), then heated at reflux under a nitrogen atmosphere for 30 minutes. The reaction was cooled to 0° C. and a saturated aqueous sodium bicarbonate solution (400 mL) was slowly added dropwise. The mixture was stirred at room temperature for 15 minutes, and then extracted with ethyl acetate (1000 mL), and the organic extract washed with saturated aqueous sodium bicarbonate (500 mL), water (2×250 mL), and brine. Dried the organic phase over anhydrous sodium sulfate, filtered, and concentrated under vacuum giving the title compound. Purification by silica gel flash chromatography with 1% ethyl acetate/methylene chloride afforded the title compound as a colorless oil (8.532 g, 45.08 mmol, 93%). LCMS M+H=190.

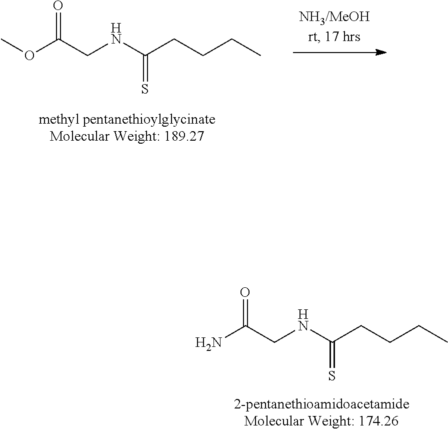

2-Pentanethioanmidoacetamide: Methyl pentanethioylglycinate (8.509 g, 44.96 mmol) was mixed with NH₃ 7N/MeOH (300 mL) and the reaction was stirred in a stoppered flask at room temperature for 17 hours. The solvent was concentrated under vacuum giving the title compound and the solid purified by silica gel flash chromatography with 10% methanol/methylene chloride to give the title compound as a white solid (5.436 g, 31.2 mmol, 69%). LCMS M+H=175.

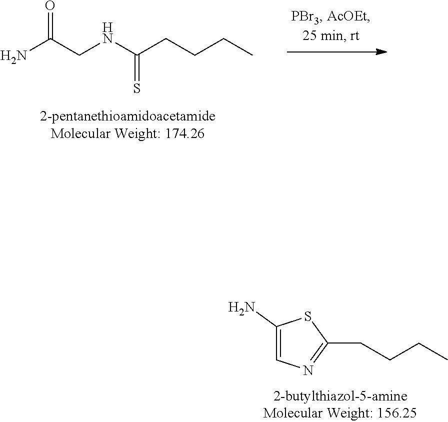

2-Butylthiazol-5-amine: A solution of 2-pentanethioamidoacetamide (4.295, 24.65 mmol) in anhydrous ethyl acetate (120 mL) was treated with phosphorous tribromide (1.89 mL, 19.72 mmol) under a nitrogen atmosphere and stirred at room temperature for 20 minutes. Added additional phosphorous tribromide (0.50 mL) and let stir for 5 minutes. The reaction mixture was diluted with ethyl acetate (500 mL) and washed with saturated aqueous sodium bicarbonate (25 mL). The aqueous wash was extracted with ethyl acetate (2×500 mL), and the organic extracts were combined and washed with brine, dried over anhydrous sodium sulfate, filtered and concentrated under vacuum giving the title compound. Purification by silica gel flash chromatography with 3% methanol/methylene chloride afforded the title product (1.921 g, 12.3 mmol, 50%). LCMS M+H=157.

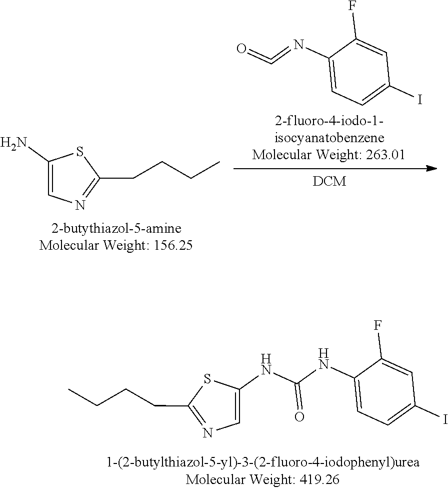

1-(2-Butylthiazol-5-yl)-3-(2-fluoro-4-iodophenyl) urea: To a solution of 2-butylthiazol-5-amine (0.4 g, 2.56 mmol) in anhydrous DCM (5 mL) was added 2-fluoro-4-iodo-1-isocyanatobenzene (Aldrich) (0.79 g, 2.816 mmol) at 0° C. The mixture was stirred at room temperature for 3 hours, and then diluted with DCM (100 mL), washed with 1N HCl aqueous solution (5 mL), water (2×25 mL), and brine. Dried the organic phase over anhydrous sodium sulfate, filtered, and concentrated under vacuum giving the title compound. Purification by silica gel flash chromatography with 10% ethyl acetate/methylene chloride afforded the title compound as a light brown solid (700 mg); yield 65%. LCMS M+H=420.

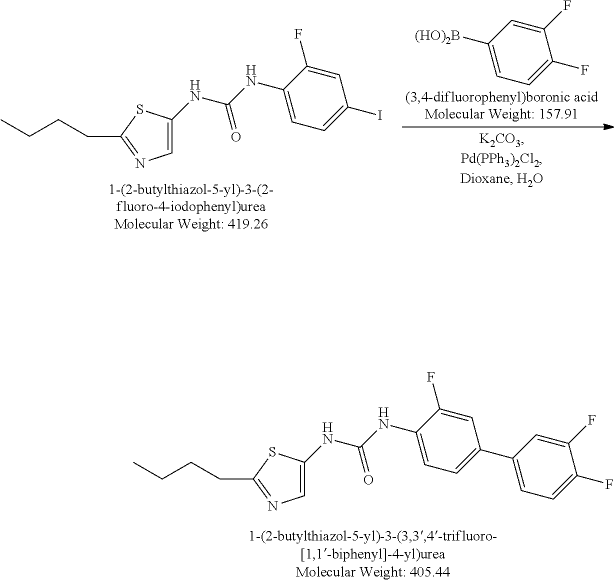 [SMILES: CCCCc1ncc(NC(=O)Nc2ccc(I)cc2F)s1 ; OB(O)c1ccc(F)c(F)c1 ; CCCCc1ncc(NC(=O)Nc2ccc(-c3ccc(F)c(F)c3)cc2F)s1]

1-(2-Butylthiazol-5-yl)-3-(3,3′,4′-trifluoro-[1,1′-biphenyl]-4-yl) urea (LC-10): Under nitrogen protection, a mixture of 1-(2-butylthiazol-5-yl)-3-(2-fluoro-4-iodophenyl)urea (0.7 g, 1.67 mmol), Pd(PPh₃)₂Cl₂ (25 mg, 0.034 mmol), K₂CO₃ (0.461 g, 3.34 mmol), 3,4-difluorophenylboronic acid (316 mg, 2.004 mmol), dioxane (25 mL), and H₂O (5 mL) was stirred at 86° C. for 16 hours. The mixture was cooled to RT than poured into water. The organic layer was extracted into ethyl acetate (150 mL) and washed twice with water (2×35 mL). The organic layer was separated, concentrated to dryness. The crude product was purified by silica gel column chromatography, DCM/ethyl acetate was used for eluting to gain 260 mg light brown solid product. Yield 38%. LCMS M+H=406 ¹H NMR (400 MHz) (DMSO) δ ppm 9.9 (s, 1H), 8.76 (d, J=1.84 Hz, 1H), 8.15 (t, d=8.56 Hz, 1H), 7.83-7.77 (m, 1H), 7.65 (dd, J=1.9 Hz, 12.8 Hz, 1H), 7.57-7.46 (m, 3H), 7.26 (s, 1H), 2.84 (t, J=7.52 Hz, 2H), 1.7-1.62 (m, 2H), 1.4-1.31 (m, 2H), 0.9 (t, J=7.34 Hz, 3H).

### Example 1.11

### Synthesis of Liquid Crystal, 5-pentyl-2-(3,3′,4′-trifluoro-[1,1′-biphenyl]-4-yl)thiazole # LC-11

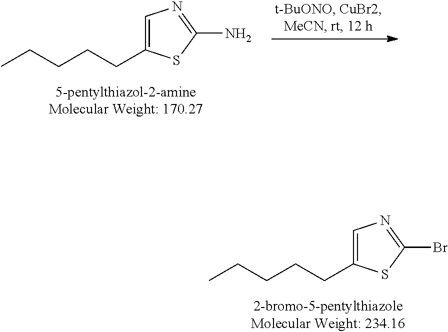

2-Bromo-5-pentylthiazole: To a suspension mixture of 5-pentylthiazol-2-amine (5 g, 29.36 mmol) in 60 mL of acetonitrile was added CuBr₂ (7.85 g, 35.21 mmol) following by t-butyl nitrite (4.64 mL, 35.21 mmol) at 0° C. while stirring with magnetic bar. The mixture was concentrated under vacuum and ethyl acetate (200 mL) was added following by 0.5M HCl aqueous solution (30 mL); the organic layer was separated, washed with brine, dried with MgSO₄, evaporated. The crude product was purified by silica gel column chromatography, eluting with hexanes:ethyl acetate (9:1) to gain 5.7 g light brown color solid product. Yield 82%.

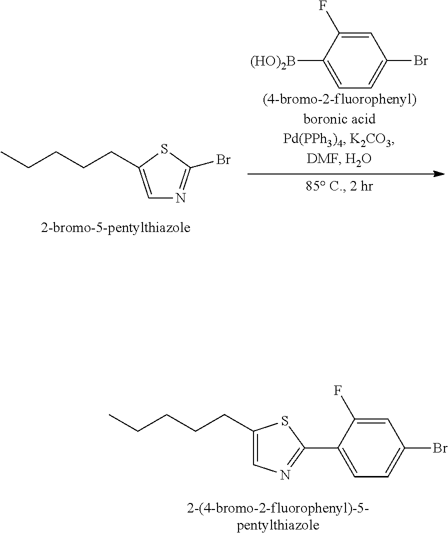 [SMILES: OB(O)c1ccc(Br)cc1F ; CCCCCc1cnc(Br)s1 ; CCCCCc1cnc(-c2ccc(Br)cc2F)s1]

2-(4-Bromo-2-fluorophenyl)-5-pentylthiazole: A mixture of (4-bromo-2-fluorophenyl)boronic acid (544.6 mg, 2.488 mmol; Aldrich), 2-bromo-5-pentylthiazole (310 mg, 1.32 mmol), Pd(PPh₃)₂Cl₂ (76.2 mg, 0.66 mmol; Aldrich) and DMF (3.0 mL; Aldrich) was stirred and bubbled with argon (Airgas) for 15 minutes at room temperature. Then a mixture of K₂CO₃ (364.8 mg, 2.64 mmol; Aldrich) in DI water (1 mL; Millipore) was added to the mixture. The resulting mixture was bubbled with argon (Airgas) for another 15 minutes and then stirred at 85° C. for 2 hours. After cooling to room temperature, the mixture was diluted with DI water (30 mL, Millipore) and extracted into ethyl acetate (30 mL; Aldrich). The organic layer was then separated, dried over MgSO₄ (anhydrous, Aldrich), filtered and concentrated to dryness under reduced pressure. Purification by column chromatography on silica gel (Aldrich) eluting with hexane:ethyl acetate (95:5) (Aldrich) gained a colorless solid (290 mg; yield 67%).

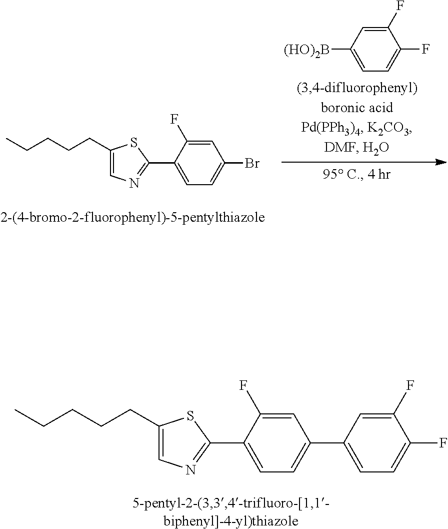 [SMILES: OB(O)c1ccc(F)c(F)c1 ; CCCCCc1cnc(-c2ccc(Br)cc2F)s1 ; CCCCCc1cnc(-c2ccc(-c3ccc(F)c(F)c3)cc2F)s1]

5-Pentyl-2-(3,3′,4′-trifluoro-[1,1′-biphenyl]-4-yl)thiazole (LC-11): A mixture of (3,4-difluorophenyl)boronic acid (322 mg, 2.039 mmol; Aldrich), 2-(4-bromo-2-fluorophenyl)-5-pentylthiazole (210 mg, 0.639 mmol), Pd(PPh₃)₂Cl₂ (36.92 mg, 0.031 mmol; Aldrich) and DMF (3.0 mL; Aldrich) was stirred and bubbled with argon (Airgas) for 15 minutes at room temperature. Then to the mixture a mixture of K₂CO₃ (176.9 mg, 1.28 mmol; Aldrich) in DI water (1 mL; Millipore) was added. The resulting mixture was then bubbled with argon (Airgas) for 15 minutes and then stirred at 95° C. for 4 hours. After letting the mixture cool to room temperature, the mixture was then diluted with DI water (30 mL; Millipore) and extracted into ethyl acetate (30 mL; Aldrich). The resulting organic layer was then separated, dried over MgSO₄ (anhydrous; Aldrich), filtered and concentrated to dryness under reduced pressure. Purification by column chromatography on silica gel (Aldrich) eluting with hexanes:ethyl acetate (95:5) (Aldrich) gained a colorless solid. LC-11 (170 mg; yield 73%). ¹H NMR (400 MHz) (CDCl₃) δ 8.31 (t, J=8.02, 1H), 7.63 (s, 1H), 7.43 (dd, J=8.66 Hz, 1.74 Hz, 1H), 7.39-7.34 (m, 1H), 7.31 (dd, J=12.2 Hz, 1.74, 1.74 Hz, 1H), 7.38-7.34 (m, 1H), 7.28-7.23 (m, 1H), 2.91 (t, J=7.52 Hz, 2H), 1.79-1.71 (m, 2H), 1.64-1.27 (m, 4H), 0.92 (t, J=4.89 Hz, 3H).

### Example 1.12

### Synthesis of Liquid Crystal, 1-(5-hexylthiophen-2-yl)-3-(3,3′,4′-trifluoro-[1,1′-biphenyl]-4-yl)urea # LC-12

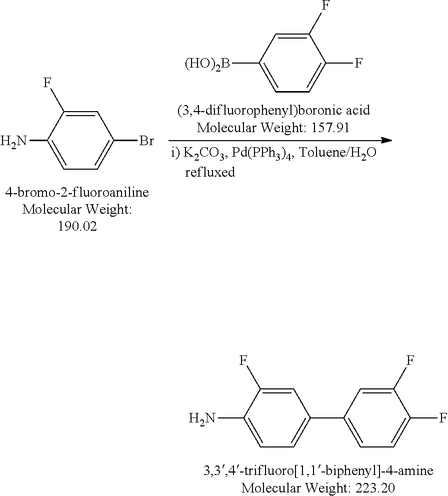 [SMILES: Nc1ccc(Br)cc1F ; OB(O)c1ccc(F)c(F)c1 ; Nc1ccc(-c2ccc(F)c(F)c2)cc1F]

3,3′,4′-Trifluoro-[1,1′-biphenyl]-4-amine: Under nitrogen protection, a mixture of 4-bromo-2-fluoroaniline (Combi Block) (19.02 g, 100 mmol), (3,4-difluorophenyl) boronic acid (Combi Block) (15.791 g, 100 mmol), Pd(PPh₃)₄ (Aldrich) (6 g, 4.92 mmol), n-BuOH (50 mL) and toluene (300 mL) was stirred and bubbled with argon for 15 minutes at room temperature. A mixture of potassium carbonate (27.642 g, 200 mmol) in H₂O (300 mL) was added to above mixture. The resulting mixture was stirred at 120° C. for 16 hours under nitrogen atmosphere. After cooling to room temperature the mixture was diluted with ethyl acetate (500 mL). The organic layer was separated, dried over MgSO₄, concentrated to dryness. The crude product was purified by silica gel flash chromatography, eluted with 10% ethyl acetate/hexanes to afford the title compound as a light brown solid (10 g, 44.8 mmol), yield 44%. LCMS M+H=224.

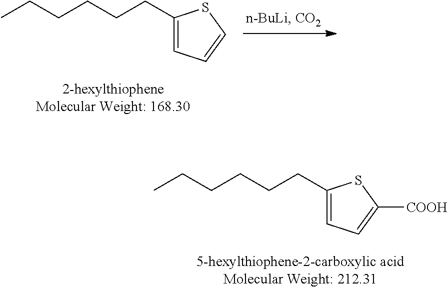

5-Hexylthiophene-2-carboxylic acid: To a mixture of 2-hexylthiophene (Combi Block) (10.0 g, 59.41 mmol) in diethyl ether (400 mL) was added 2.5 M solution of n-BuLi in diethyl ether (Aldrich) (26.14 mL, 63.35 mmol) at room temperature under a nitrogen atmosphere; the resulting mixture was stirred at room temperature for 30 minutes than heated to refluxed for 1 hour. The reaction was cooled to room temperature and stirred for 1 hour. The mixture was poured quickly to dry-ice (145 g) in diethyl ether (365 mL), the slurry mixture was stirred for 2 hours. Water (100 mL) was added; the organic layer was separated and washed with 5% NaOH aqueous solution. The aqueous layers were combined and acidified with HCl concentrated. The white precipitate was collected by filtration and washed with water then dried in vacuo oven to afford the title compound as a colorless solid (10.0 g, 47.1 mmol); yield was 79%. LCMS M+H=213.

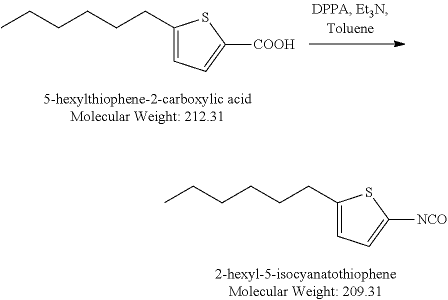

2-Hexyl-5-isocyanatothiophene: Diphenylphosphoryl azide (Aldrich) (2.4 mL, 11.0 mmol) was added to a solution mixture of 5-hexylthiophene-2-carboxylic acid (2.21 g, 10.41 mmol) in anhydrous toluene (20.0 mL) followed by Et₃N (6 mL, 42.98 mmol) at room temperature under nitrogen atmosphere, the resulting mixture was stirred at room temperature for 1 hour then 90° C. for further 1 hour. The mixture was cooled to room temperature; the oily precipitate was separated by decantation. The solution layer was concentrated under reduced pressure; the residue was purified by a short silica gel column, eluted with 10% ethyl acetate/hexane afforded the title compound as an oil product (1.26 g, 6.019 mmol), yield 58%. LCMS M+H=210.

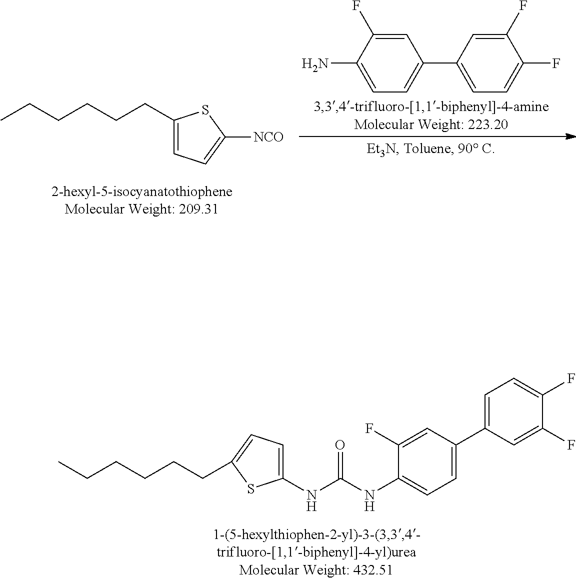

1-(5-Hexylthiophen-2-yl)-3-(3,3′,4′-trifluoro-[1,1′-biphenyl]-4-yl) urea (LC-12): A stirred mixture of 2-hexyl-5-isocyanatothiophene (0.419 g, 2.00 mmol), 3,3′,4′-trifluoro-[1,1′-biphenyl]-4-amine (0.468 g, 2.1 mmol), Et₃N (1 mL, 7.1 mmol) in toluene (5.0 mL) was stirred at 90° C. for 5 hours. After cooling to room temperature the mixture was diluted with ethyl acetate (150 mL), washed with water, citric acid aqueous solution, brine, dried MgSO₄, concentrated. The crude product was purified by silica gel flash chromatography with 10% ethyl acetate/hexanes then recrystallized from hexanes to afford the title compound as an off white solid (205 mg, 0.47 mmol); yield was 23.5%. LCMS M+H=434.

### Example 1.13

### Synthesis of Liquid Crystal, 3,3′,4′-trifluoro-N-(5-pentylthiophen-2-yl)-[1,1′-biphenyl]-4-carboxamide # LC-13

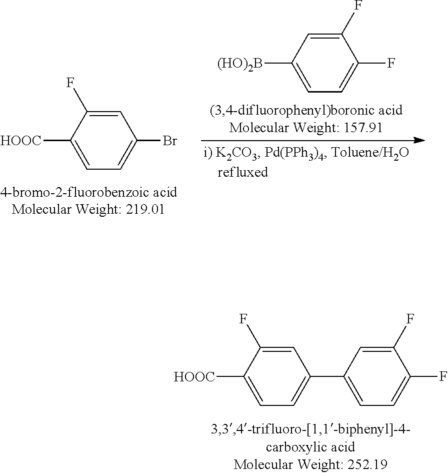 [SMILES: O=C(O)c1ccc(Br)cc1F ; OB(O)c1ccc(F)c(F)c1 ; O=C(O)c1ccc(-c2ccc(F)c(F)c2)cc1F]

3,3′,4′-Trifluoro-[1,1′-biphenyl]-4-carboxylic acid: Under nitrogen protection, a mixture of 4-bromo-2-fluorobenzoic acid (Combi Block) (21.901 g, 100 mmol), (3,4-difluorophenyl) boronic acid (Combi Block) (15.791 g, 100 mmol), Pd(PPh₃)₄ (Aldrich) (6 g, 4.92 mmol) and toluene (300 mL) was stirred and bubbled with argon for 15 minutes at room temperature. A mixture of potassium carbonate (27.642 g, 200 mmol) in H₂O (300 mL) was added to above mixture. The resulting mixture was stirred at 120° C. for 16 hours under nitrogen atmosphere. After cooling to room temperature the white color solid was filtered off. The water layer was separated. The organic layer was washed with 3N NaOH aqueous solution. The water layers were combined, acidified with 6 N HCl aqueous solution. The product was precipitated, collected by filtering with suction and washed with water (300 mL); the off white solid product was air dried to gain 11.31 g off white solid product. Yield 45%. LCMS M+H=253.

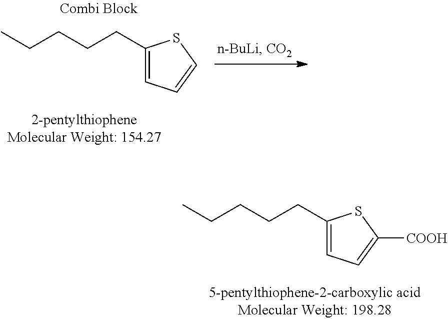

5-Pentylthiophene-2-carboxylic acid: To a mixture of 2-pentylthiophene (Combi Block) (10.0 g, 64.82 mmol) in diethyl ether (400 mL) was added 2.5 M solution of n-BuLi in diethyl ether (Aldrich) (28.25 mL, 70.64 mmol) at room temperature under a nitrogen atmosphere; the resulting mixture was stirred at room temperature for 30 minutes than heated to reflux for 1 hour. The reaction was cooled to room temperature and stirred for 1 hour. The mixture was poured quickly to dry-ice (145 g) in diethyl ether (365 mL), the slurry mixture was stirred for 2 hours. Water (100 mL) was added; the organic layer was separated and washed with 5% NaOH aqueous solution. The aqueous layers were combined and acidified with concentrated HCl. The white precipitate was collected by filtration and washed with water then dried in vacuo oven to afford the title compound as a colorless solid (10.0 g, 50.43 mmol); yield was 77%. LCMS M+H=199.

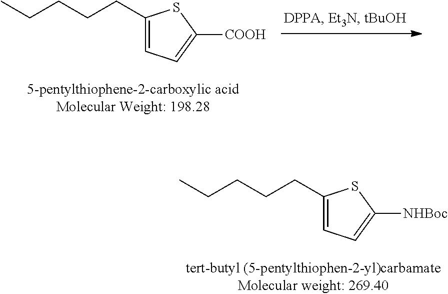 [SMILES: CCCCCc1ccc(C(=O)O)s1 ; CCCCCc1ccc(NC(=O)OC(C)(C)C)s1]

tert-Butyl(5-pentylthiophen-2-yl) carbamate: Diphenylphosphoryl azide (DPPA, Aldrich) (11.00 mL, 50.43 mmol) was added to a solution mixture of 5-pentylthiophene-2-carboxylic acid (10.0 g, 50.43 mmol) in anhydrous t-BuOH (200.0 mL) following by Et₃N (7.04 mL, 50.43 mmol) at room temperature under nitrogen atmosphere, the resulting mixture was stirred at 90° C. for 16 hours. The mixture was concentrated to dryness; the residue dissolved into ethyl acetate (350 mL), washed with saturated NaHCO₃ aqueous, citric acid aqueous solution, brine; dried over MgSO₄. The solvent was removed under reduced pressure; the residue was washed with hexanes. The brown color solid material was removed by filtering and the filtrate was concentrated under reduced pressure. The crude product was purified by silica gel flash chromatography, eluted with 10% ethyl acetate/hexane afforded the title compound as an off white solid (6.24 g, 23.19 mmol, yield 46%. LCMS M+H=270.

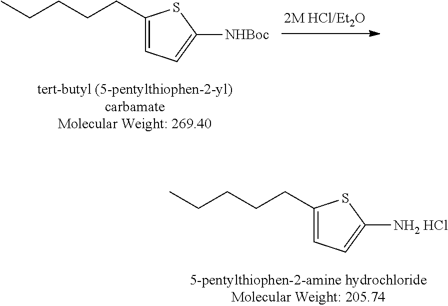

5-Pentylthiophen-2-amine hydrochloride: A solution of 2M HCl in diethyl ether (Aldrich) (10 mL, 20.0 mmol) was added to a mixture of tert-butyl(5-pentylthiophen-2-yl) carbamate (1.346 g, 5.00 mmol) in dioxane (10 mL). The mixture was stirred at room temperature for 16 hours. The solvents were evaporated under reduced pressure to dryness and the residue was washed with diethyl ether (50 mL). The product was dried under vacuum giving the title compound as a light brown color solid (1.00 g, 4.86 mmol); yield was 97.2%. LCMS M+H=170.

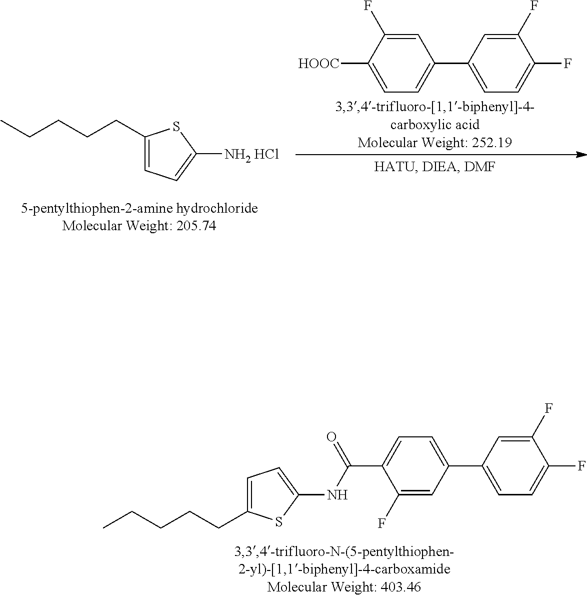

3,3′,4′-Trifluoro-N-(5-pentylthiophen-2-yl)-[1,1′-biphenyl]-4-carboxamide (LC-13): To a mixture of 3,3′,4′-trifluoro-[1,1′-biphenyl]-4-carboxylic acid (0.675 g, 2.677 mmol) in DMF (5.0 mL) was added HATU (Aldrich) (1.018 g, 2.677 mmol) following by DIEA (1.856 mL, 10.71 mmol) at room temperature under nitrogen atmosphere. The mixture was stirred at room temperature for 30 minutes before a mixture of 5-pentylthiophen-2-amine hydrochloride in DMF (5 mL) was added. The resulting mixture was stirred at room temperature under nitrogen atmosphere for 16 hours. The mixture was diluted with ethyl acetate, washed with water, citric acid aqueous solution, brine, dried MgSO₄, concentrated. The crude product was purified by silica gel flash chromatography with 10% ethyl acetate/hexanes then recrystallized from hexanes to afford the title compound as an off white solid (286 mg); yield was 26%. LCMS M+H=404. H NMR (400 MHz) (DMSO-d6) δ ppm 11.46 (s, 1H), 7.95 (dd, J=9.8 Hz, 3.8 Hz, 1H), 7.78-7.67 (m, 4H), 7.61-77.54 (m, 1H), 6.65 (d, J=3.5 Hz, 1H), 6.59 (d, J=3.3 Hz, 1H), 2.71 (t, J=7.44 Hz, 2H), 1.69-1.58 (m, 2H), 1.32-1.31 (m, 4H), 0.92 (t, J=6.4 Hz, 3H).

### Comparative Example 2.1

### Synthesis of Comparative Liquid Crystal #1 (CLC-1)

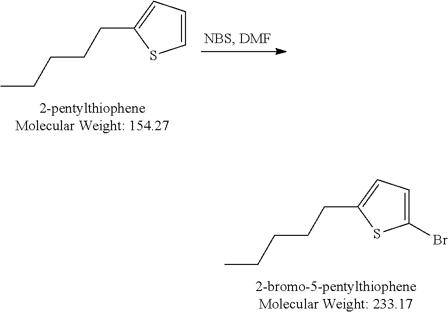

2-Bromo-5-pentylthiophene: To a solution mixture of 2-pentylthiophene (Aldrich) (5 g, 32.41 mmol) in anhydrous DMF (60 mL) at RT was added slowly NBS (Aldrich) (5.77 g, 32.4 mmol). The resulting mixture was stirred at RT for 1.5 hours. Water (240 mL) was added followed by ethyl acetate (300 mL). The organic layer was separated, concentrated, dried MgSO₄, concentrated to gain 7.5 g, yield 99%. LCMS M+H=235.

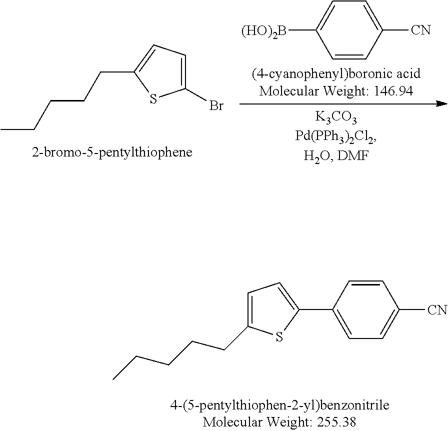 [SMILES: CCCCCc1ccc(Br)s1 ; N#Cc1ccc(B(O)O)cc1 ; CCCCCc1ccc(-c2ccc(C#N)cc2)s1]

4-(5-Pentylthiophen-2-yl)benzonitrile: Under nitrogen protection, a solution mixture of potassium carbonate (1.77 g, 12.8 mmol) in H₂O (5 mL) was added to a mixture of 2-bromo-5-pentylthiophene (1.51 g, 6.42 mmol), Pd(PPh₃)₂Cl₂ (Aldrich) (0.379 g, 0.32 mmol), and (4-cyanophenyl)boronic acid (Combi Block) (1.03 g, 7.06 mmol), in DMF (20 mL) at RT. The resulting mixture was stirred at 85° C. for 16 hours. After cooling to RT the mixture was diluted with ethyl acetate (50 mL); water layer was separated; organic layer was washed with brine dried MgSO₄, concentrated. The residue was purified by silica-gel column chromatography, gained 0.718 g colorless solid product. Yield 43%. LCMS M+H=256. ¹H NMR (500 MHz) (CDCl₃) δ ppm 7.63-7.6 (m, 4H), 7.24 (d, J=3.5 Hz, 1H), 6.79 (d, J=4 Hz, 1H), 2.83 (t, J=7.75 Hz, 2H), 1.72-1.68 (m, 2H), 1.39-1.34 (m, 4H), 0.91 (t, J=7 Hz, 3H).

### Example 3.1

### Composition Polarization Observations

The synthesized compositions can be examined with an optical microscope in a crossed polarization lighting condition to characterize their liquid crystal behavior and to study the composition's birefringence, or the difference between high and low refractive index of anisotropic liquid crystal molecules.

For the setup, a microscope (BX-53F; Olympus, Tokyo, Japan) can be setup for polarizing microscopy with the analyzer attachment (U-PA, Olympus) rotated 90 degrees from the polarizer filter (BX45-PO, Olympus) all within the optical path from an adjustable 100-watt halogen light attachment (U-LH100HG, Olympus). In addition, to capture the images the microscope can be also equipped with a video camera adapter (U-TVO.35XC-2, Olympus) which is further connected to a computer for capturing the images. For measurement, the samples can be placed on the microscope's stage placing them in the halogen lamp's optical path between the polarizer and the analyzer. Since the polarization between the analyzer and polarizer are completely mismatched by 90 degrees, if the sample is isotropic, e.g. glass, the light emitted from the source would be nearly completely blocked by the second polarizer because the unblocked polarized light exiting the first polarizer would not bend and would be subsequently blocked by the analyzer. The blockage of the remaining light by the mismatched analyzer is due to the inability of isotropic materials to change the polarization direction of light passing through them. However, if an anisotropic sample is placed in between both polarizer films, the polarized light passing through the sample material can change polarization if the sample exhibits birefringence properties resulting in a light component that will not be blocked by the analyzer, or a detected interference pattern. Since glass is isotropic and has minimal effect light polarization, the liquid crystal compositions can be sandwiched between two glass substrates during the measurements with minimal interference upon the measurements.

In addition to the microscope setup, a heating stage (FP 82 HT, Mettler Toledo, Columbus, Ohio, USA) and associated controller (FP 90, Mettler Toledo) can be used to heat the samples sandwiched in glass to specified temperatures before measurements are taken allowing determination of the birefringence properties of the samples at specific temperatures in order to determine their phase as a function of temperature.

If a nematic or smectic phase was present after cooling and the samples exhibited birefringence, it was detected as transformed light component at the microscope or an interference pattern of light. If the material was in an isotropic phase, it was observed by the detection of no discernible light at the microscope, or darkness due to no transformation of light and subsequent blockage by the second polarizer.

For the measurements, the liquid crystal compound, LC-1, made as described above, was placed into the setup to measure the phase behavior. Starting at 20° C., an image was captured to baseline the mixture phase. Then, during first heating cycle the liquid crystal molecules in the sample were heated at a rate of 10° C. per minute until a black image was observed, which indicated an isotropic phase change, and the temperature was recorded. Then during cooling, when an interference color image was observed as a result of the samples transition back to nematic and/or smectic from isotropic, the phase transition temperature was re-verified and an image was recorded. Then, during second heating cycle, the samples were heating at a heating rate of 5° C. per min in order to carefully record the phase change temperature. This procedure was repeated for the other LC compounds, results in Table 1.

TABLE 1
Observed Transition Temperatures for Various Compounds.

| | LC Phase Transition |
|---|---|
| Compounds | Temperatures [° C.] |
| LC-1 | C 58 I |
| LC-2 | C 47 Sm 80 N 85 I |
| LC-3 | C 58 N 142 I |
| LC-4 | C 82 Sm 165 N 170 I |
| LC-5 | C 90 I |
| LC-6 | C 155 I |
| LC-7 | C 130 N 156 I |
| LC-9 | C 177 N 226 I |
| LC-10 | C 210 N 230 I |
| LC-11 | C 46 Sm 120 I |
| LC-12 | C 135 N 185 I |
| LC-13 | C 95 N 103 I |

### Example 4.1: Preparation of Liquid Crystal Mixtures

For optimum PDLC functionality it is helpful for the liquid crystal system to have a specific combination of physical properties. One particularly useful property is a wide nematic temperature range. The target nematic range of smart window film was −20° C. to +80° C. Historically, it was hard for a single liquid crystal to achieve such a wide nematic range. As a result, a variety of different liquid crystals were used to achieve the desired nematic temperature range. To achieve such a formulation, liquid crystals with low melting points were mixed with liquid crystals having high melting points, good miscibility, and solubility. In the present embodiments, the mixture compounds were low melting compounds based on a two or three six-membered cyclic cores.

An example of a mixed liquid crystal formulation is provided. For Formulation 2 (F-2), a mixture of 5CB (47.4 wt %, Qingdao QY Liquid Crystal Co., Ltd., Chengyang, Qingdao, China), 7CB (10.0 wt %, Qingdao QY Liquid Crystal), 80CB (5.2 wt %, Qingdao QY Liquid Crystal), 5CT (9.3 wt %, Qingdao QY Liquid Crystal), 5CCB (13.9 wt %, Qingdao QY Liquid Crystal), 6CHBT (9.1 wt %, Aldrich), and LC-1 (5.1 wt %) was mixed in a clear sample bottle and then put in a shaker (VWR Advanced Digital Shaker, Model-3500 ADV 120V) overnight to mix the liquid crystal compounds. The sample bottle was then heated on a hot plate at 120° C. to dissolve any remaining components. Then gentle shaking by hand was done for one to two minutes until a clear solution appeared. The mixture was then kept on hot plate for another two minutes. The resulting clear solution was then cooled at room temperature and then was confirmed to have a turbid liquid appearance, which is typical for liquid crystal formulation. A small amount (5-10 mg) of formulation-2 was taken to measure differential scanning calorimetry (DSC) (TA Instrument, Model-Q2000). A single phase transition peak was measured at 83.9° C. Normally if the mixture is homogeneous then it should have a single phase transition temperature different from the individual melting temperature of the components. This single phase transition temperature termed as eutectic temperature the presence of the single transition confirmed a eutectic mixture.

Additional formulation mixtures F-1 and F-3 through F-10 were also generated using the same methodology with the exception that the mass ratios were varied according to the mass ratios in Table 2.

TABLE 2
Mixtures Formulations and Associated Phase Properties.

| | | | | | | | LC | Nematic |
|---|---|---|---|---|---|---|---|---|
| | 5CB | 7CB | 8OCB | 5CT | 5CCB | 6CHBT | Comp/ | Range |
| Mixture | (wt %) | (wt %) | (wt %) | (wt %) | (wt %) | (wt %) | (wt %) | [° C.] |
| F-1 | 49.9 | 10.5 | 5.5 | 9.9 | 14.7 | 9.5 | — | C −20 N |
| | | | | | | | | 84.3 I |
| F-2 | 47.4 | 10.0 | 5.2 | 9.3 | 13.9 | 9.1 | LC-1/ | C −20 N |
| | | | | | | | 5.1 | 83.9 I |
| F-3 | 47.6 | 10.0 | 5.1 | 9.4 | 13.9 | 9.0 | LC-3/ | C −20 N |
| | | | | | | | 5.0 | 76.2 I |
| F-4 | 47.4 | 10.0 | 5.2 | 9.4 | 13.9 | 9.1 | LC-10/ | C −20 N |
| | | | | | | | 5.0 | 73.4 I |
| F-5 | 47.3 | 10.0 | 5.2 | 9.4 | 13.9 | 9.1 | LC-5/ | C −20 N |
| | | | | | | | 5.1 | 80.5 I |
| F-6 | 47.4 | 10.0 | 5.1 | 9.3 | 13.9 | 9.1 | LC-7/ | C −20 N |
| | | | | | | | 5.2 | 83.5 I |
| F-7 | 47.3 | 10.0 | 5.2 | 9.4 | 13.9 | 9.0 | LC-6/ | C −20 N |
| | | | | | | | 5.2 | 86.1 I |
| F-8 | 47.4 | 10.0 | 5.1 | 9.4 | 13.9 | 9.1 | LC-2/ | C −20 N |
| | | | | | | | 5.1 | 83.0 I |
| F-9 | 47.3 | 10.0 | 5.2 | 9.3 | 13.9 | 9.1 | LC-9/ | C −20 N |
| | | | | | | | 5.2 | 83.2 I |
| F-10 | 47.4 | 10.0 | 5.2 | 9.4 | 13.9 | 9.1 | LC-8/ | C −20 N |
| | | | | | | | 5.0 | 76.0 I |

### Example 5.1: Fabrication of LC-Based Dimmable Device Using Capillary Method

In Example 5.1, a selectively dimmable device based on a heterocyclic-based liquid crystal compound with positive dielectric anisotropy was fabricated using the capillary method. For the capillary method, a homogeneous-type liquid crystal test cell (KSRO-15/B107M1NSS05, E.H.C Co. Ltd, Tokyo, Japan) was used for making the device. The test cell is comprised of two substrates with supports that defined an active alignment area in between the two substrates. The size of the glass/ITO substrate was 20 mm×25 mm with a sheet resistance about 100 Ω/sq and the active alignment area was about 10 mm×10 mm with a cell gap of 15 m. The cell was procured pre-coated with a polyamide alignment layer (LX-1400, Hitachi-Kasei Shoji Co., Ltd., Tokyo, Japan) so that no application of the alignment layers was necessary. Also, since the geometry of the cell included supports to ensure preservation of the cell gap, separate spacers were not required to be inserted into the cell before application of the liquid crystal mixture.

First, the test cell was baked at 150° C. for 30 min before injection of liquid crystal mixture to remove any impurities and any vapors inside the test cell. A liquid crystal mixture, e.g., F-1 was then mixed with a polymer precursor LC-242 (BASF Corporation, Florham Park, N.J., USA), a chiral dopant, e.g. R-811 (EMD Chemical. Gibbstown, N.J., USA) and photo initiator, Igracure® 651 (BASF) in mass ratios of 88 wt %, 10 wt %, 1 wt % and 1 wt %. The resulting liquid crystal composition was then mixed with an ultrasonic homogenizer to thoroughly mix the solution.

Next, the test cells were pretreated for the liquid crystal injection by warming the substrates at 100° C. for 5 minutes on a hot plate. Then, the hot coating liquid crystal composition was injected near the opening of the test cell. The solution was then allowed to enter into the test cell by capillary action until it coated the entire active alignment area. In some embodiments, the test cell was put on hot plate after injecting coating formulation to help ensure homogenous coverage of the liquid crystal. The resulting coated substrates were then cool down slowly and kept at room temperature for 3 minutes to stabilize the alignment between the liquid crystal materials and reactive mesogen. After cooling, the result was a layered cell assembly, ready for ultraviolet (UV) radiation curing (UV-curing).

Then, the layered cell assembly was then put on a stainless steel plate to provide a thermal sink so that the cell did not overheat during UV-curing. The assembly was then cured under a UV LED (365 nm, Larsen Electronics, Kemp, Tex. USA) at an output of about 50 mW/cm² incident power for about 1.5 minute on each side to photo polymerize the LC-242. To keep the temperatures of the assembly from localized blooming as a by-product of the UV irradiation, the orientation of the sample was switched at approximately 1.5-minute intervals by flipping the assembly over. The result was an unsealed, dimmable assembly.

After UV-curing, the edges were optionally sealed with a sealant to protect the liquid crystal element. After encapsulation, the assembly can then be baked in an oven at 80° C. for 30 minutes, which can result in a sealed, dimmable assembly.

Next, the dimmable assembly was placed in electrical communication with a voltage source by electrically by attaching a conducting clamp and wire in electrical communication with a voltage source to each conductive substrate such that when a voltage is applied across the voltage source, an electrical field is applied across the liquid crystal composition.

While not wanting to be limited by theory it is thought that the voltage source will provide the necessary electrical field across the device to rotate the dispersed liquid crystals resulting in a mismatch of the index of refraction the liquid crystal element. The result was selectively dimmable device #1 (DD-1)

### Example 5.2: Fabrication of Additional LC-Based Dimmable Devices

In Example 5.2, additional devices can be formulated using the same methodology as in Example 5.1 with the exception that the mass ratios and additives were varied according to Table 3. For devices with more than two liquid crystal components, the components (e.g., 5CB, 7CB, 80CB, 5CT, 5CCB, and 6CHBT) were obtained from Qingdao QY Liquid Crystal Co., Ltd. in Chengyang, Qingdao, China. The mixtures were mixed in a clear sample bottle, placed on a shaker (VWR Advanced Digital Shaker, Model-3500 ADV 120V), and shaken overnight to mix the liquid crystal compounds well. The sample bottle was then heated on a hot plate at 120° C. to dissolve any remaining components followed by gentle shaking by hand for one to two minutes until a clear solution appeared. The mixture was then kept on hot plate for another two minutes. The resulting clear solution was cooled to room temperature until it has a turbid liquid appearance, resulting in a liquid crystal formulation. Liquid crystal mixtures were varied according to Table 2, additional compounds used were Igracure® 651 (BASF Corporation, Florham Park, N.J., USA) and R-811(Merck KGaA, Darmstadt, Germany) and C-242 (BASF).

TABLE 3
Variances between the Fabricated Dimmable Elements.

| | | Liquid Crystal | Polymer Additives | | |
|---|---|---|---|---|---|
| | | Components Mass | (Mass Fraction Relative | | Dielectric |
| Device | Example | Fractions | to LC Composition) | Polyimide | Anisotropy |
| DD-1 | Example | F-1 (88.0 wt %) | LC-242 (10.0 wt %) | LX-1400 | Positive |
| | 5.1 | R-811 (1.0 wt %) | Igracure 651 (1.0 wt %) | | |
| DD-2 | Example | F-2 (88.0 wt %) | LC-242 (10.0 wt %) | LX-1400 | Positive |
| | 5.2 | R-811 (1.0 wt %) | Igracure 651 (1.0 wt %) | | |
| DD-3 | Example | F-3 (88.0 wt %) | LC-242 (10.0 wt %) | LX-1400 | Positive |
| | 5.2 | R-811 (1.0 wt %) | Igracure 651 (1.0 wt %) | | |
| DD-4 | Example | F-4 (88.0 wt %) | LC-242 (10.0 wt %) | LX-1400 | Positive |
| | 5.2 | R-811 (1.0 wt %) | Igracure 651 (1.0 wt %) | | |
| DD-5 | Example | F-5 (88.0 wt %) | LC-242 (10.0 wt %) | LX-1400 | Positive |
| | 5.2 | R-811 (1.0 wt %) | Igracure 651 (1.0 wt %) | | |
| DD-6 | Example | F-6 (88.0 wt %) | LC-242 (10.0 wt %) | LX-1400 | Positive |
| | 5.2 | R-811 (1.0 wt %) | Igracure 651 (1.0 wt %) | | |
| DD-7 | Example | F-7 (88.0 wt %) | LC-242 (10.0 wt %) | LX-1400 | Positive |
| | 5.2 | R-811 (1.0 wt %) | Igracure 651 (1.0 wt %) | | |
| DD-8 | Example | F-8 (88.0 wt %) | LC-242 (10.0 wt %) | LX-1400 | Positive |
| | 5.2 | R-811 (1.0 wt %) | Igracure 651 (1.0 wt %) | | |
| DD-9 | Example | F-9 (88.0 wt %) | LC-242 (10.0 wt %) | LX-1400 | Positive |
| | 5.2 | R-811 (1.0 wt %) | Igracure 651 (1.0 wt %) | | |
| DD-10 | Example | F-10 (88.0 wt %) | LC-242 (10.0 wt %) | LX-1400 | Positive |
| | 5.2 | R-811 (1.0 wt %) | Igracure 651 (1.0 wt %) | | |

### Example 6.1: Optical Measurements

In Example 6.1, the optical characteristics of the fabricated dimmable devices were characterized by measuring the light allowed to pass through each, both with and without an electric field present. Device were wired at two ITO edge by indium shot and a thin Cu-wire. Light transmittance data for the samples were measured using a haze meter (NDH-7000; Nippon Denshoku Co, Tokyo, Japan) with each respective sample placed inside the device. A home built automatic haze measurement system were built and used thereby. Haze was measured from 0 to 100 V with 5V increment.

As shown in FIG. 5, the device DD-8 (containing F-8, which contains LC-2) and DD-2 (containing F-2, which contains LC-1) exhibits on state haze 76% and 70%, respectively, with a driving voltage of 40V. This result is much higher than the corresponding control device (DD-1, which contains none of the new liquid crystal compounds (LC-1 through LC-13) of the present disclosure).

Additional measurements are planned to characterize the additional planned dimmable devices. It is envisioned that those devices will behave similar to the device measured and disclosed herein.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of any claim. No language in the specification should be construed as indicating any non-claimed element essential to the practice of the disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A liquid crystal composition comprising a first liquid crystalline compound represented by the following formula: 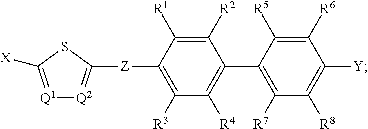
wherein Z is —CH═N—, —N═CH—, —CH₂—NH—, —NH—CH₂—, —C(O)O—, —OC(O)—, —C(O)—NH—, —NH—C(O)—, —O—, —NH—C(O)—NH—, or a bond;
R¹, R², R³, R⁴, R⁵, R⁶, R⁷ and R⁸ are independently H, F, Cl, Br, —CN or —NCS;
Q¹ and Q² are independently CH, substituted C, or N;
X is C₃₋₈ hydrocarbyl or C₂₋₇ hydrocarbyloxy; and
Y is H or F.

2. The liquid crystal composition of claim 1, wherein Z is: —CH═N—, —N═CH—, —CH₂—NH—, —NH—CH₂—, or a bond.

3. The liquid crystal composition of claim 2, wherein the first liquid crystalline compound is selected from the following:

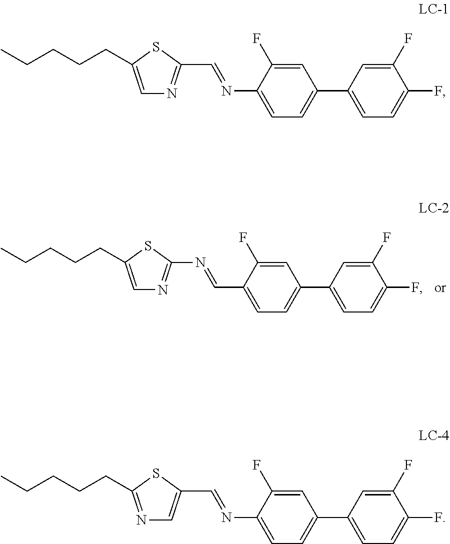 [SMILES: CCCCCc1cnc(/C=N/c2ccc(-c3ccc(F)c(F)c3)cc2F)s1 ; CCCCCc1cnc(/N=C/c2ccc(-c3ccc(F)c(F)c3)cc2F)s1 ; "or" ; CCCCCc1ncc(/C=N/c2ccc(-c3ccc(F)c(F)c3)cc2F)s1]

4. The liquid crystal composition of claim 1, wherein Z is —C(O)O— or —OC(O)—.

5. The liquid crystal composition of claim 4, where the first liquid crystalline compound is:

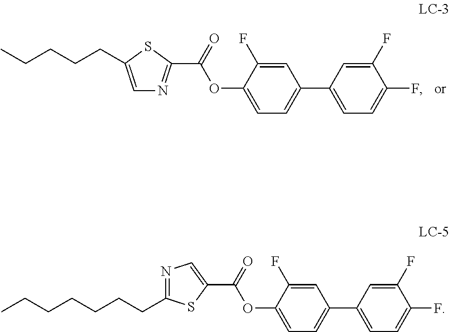 [SMILES: CCCCCc1cnc(C(=O)Oc2ccc(-c3ccc(F)c(F)c3)cc2F)s1 ; "or" ; CCCCCCCc1ncc(C(=O)Oc2ccc(-c3ccc(F)c(F)c3)cc2F)s1]

6. The liquid crystal composition of claim 1, wherein Z is: —NH—C(O)— or —C(O)—NH—.

7. The liquid crystal composition of claim 6, where the first liquid crystalline compound is selected from the following:

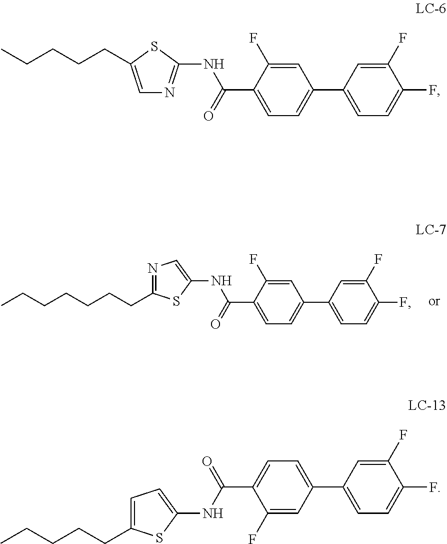 [SMILES: CCCCCc1cnc(NC(=O)c2ccc(-c3ccc(F)c(F)c3)cc2F)s1 ; CCCCCCCc1ncc(NC(=O)c2ccc(-c3ccc(F)c(F)c3)cc2F)s1 ; "or" ; CCCCCc1ccc(NC(=O)c2ccc(-c3ccc(F)c(F)c3)cc2F)s1]

8. The liquid crystal composition of claim 1, wherein Z is —NH—C(O)—NH—.

9. The liquid crystal composition of claim 8, wherein the first liquid crystalline compound is selected from the following:

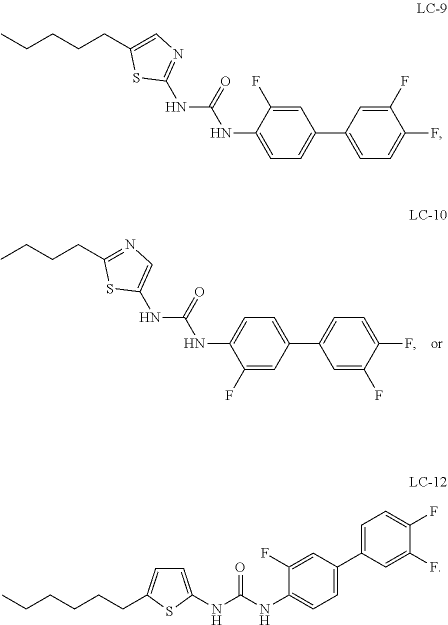 [SMILES: CCCCCc1cnc(NC(=O)Nc2ccc(-c3ccc(F)c(F)c3)cc2F)s1 ; CCCCc1ncc(NC(=O)Nc2ccc(-c3ccc(F)c(F)c3)cc2F)s1 ; "or" ; CCCCCCc1ccc(NC(=O)Nc2ccc(-c3ccc(F)c(F)c3)cc2F)s1]

10. The liquid crystal composition of claim 1, wherein Z is —O—.

11. The liquid crystal composition of claim 10, wherein the first liquid crystalline compound is:

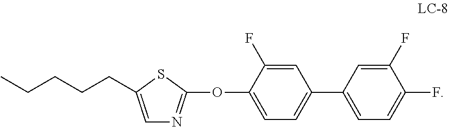 [SMILES: CCCCCc1cnc(Oc2ccc(-c3ccc(F)c(F)c3)cc2F)s1]

12. The liquid crystal composition of claim 1, wherein Z is a bond.

13. The liquid crystal composition of claim 12, wherein the first liquid crystalline compound is:

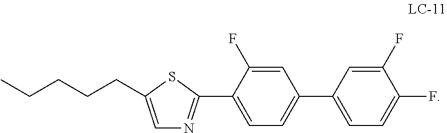 [SMILES: CCCCCc1cnc(-c2ccc(-c3ccc(F)c(F)c3)cc2F)s1]

14. A liquid crystal mixture comprising the composition of claim 1, further comprising a second liquid crystalline compound of the formula: 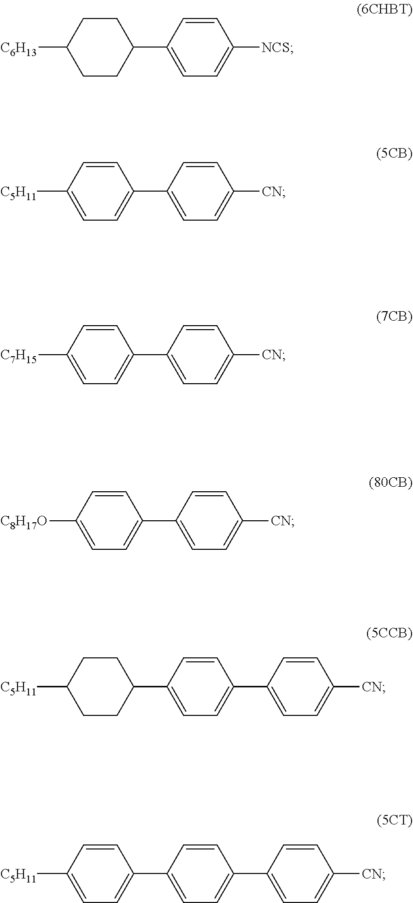
or any combination thereof.

15. A polymer dispersed liquid crystal (PDLC) composition comprising: the liquid crystal mixture of claim 14 and a polymer.

16. The PDLC composition of claim 15, wherein the polymer is a reaction product of a mixture comprising: a polymer precursor, a chiral dopant, and a photoinitiator.

17. The PDLC composition of claim 16, wherein the elements have the following weight percentages:
88% of the liquid crystal mixture;
10% of the polymer precursor, wherein the polymer precursor is LC-242;
1% of the chiral dopant, wherein the chiral dopant is R-811; and
1% of the photoinitiator, wherein the photoinitiator is Igracure 651.

18. A method of preparing the PDLC composition of claim 16, comprising the steps of:
a) combining the liquid crystalline mixture with the polymer precursor LC-242, the chiral dopant, and the photoinitiator;
b) mixing the resulting composition with an ultrasonic homogenizer; and
c) warming the resulting mixture at 100° C. for 5 minutes on a hot plate.

19. A liquid crystal element, the element comprising: a transparency changing layer, comprising the PDLC composition of claim 16, disposed between a first alignment layer and a second alignment layer.

20. A selectively dimmable device comprising:
the liquid crystal element of claim 19 disposed between a first conductive substrate and a second conductive substrate; and
a voltage source;
wherein the first conductive substrate, the second conductive substrate, and the element are in electrical communication with the voltage source such that when a voltage is applied from the voltage source, an electric field is generated across the liquid crystal element.

21. The device of claim 20, having a haze of at most 10% when there is no voltage applied, but a haze of at least 35% when a voltage of 40 volts is applied across the device.

22. The device of claim 20, the device having a haze of at most 10% when there is no voltage applied, but a haze of at least 65% when a voltage of 40 volts is applied across the device.

23. The device of claim 20, where the substrates are flexible so that the device forms a flexible sheet.

24. The device of claim 20, further comprising a removable backing.
